(19) United States
(12) Patent Application Publication
(10) Pub. No.: US 2025/0362637 A1
(43) Pub. Date: Nov. 27, 2025

(54) IMAGE FORMING METHOD AND IMAGE FORMING SYSTEM

(71) Applicant: Konica Minolta, Inc., Tokyo (JP)

(72) Inventors: Natsuko KUSAKA, Tokyo (JP); Yuka SUHARA, Tokyo (JP); Kaori AKUTSU, Tokyo (JP)

(21) Appl. No.: 19/212,818

(22) Filed: May 20, 2025

(30) Foreign Application Priority Data
May 22, 2024 (JP) 2024-083196

(51) Int. Cl. G03G 15/00; G03G 9/087

(52) U.S. Cl. CPC G03G 15/6594; G03G 9/08755; G03G 15/6591; G03G 2215/0604

(57) ABSTRACT

An electrophotographic image forming method includes fixing an electrostatic charge image developing toner onto a resin recording medium to form an image. The content of a saturated hydrocarbon compound having 16 to 35 carbon atoms is 1,000 ppm by mass or less with respect to the total mass of the electrostatic charge image developing toner. When an image having an adhesion amount of 4 g/m² or greater is formed on the resin recording medium, a peak density Spd of protrusions on a surface of the image is 5,000 mm⁻² or greater.

### CROSS-REFERENCE TO RELATED APPLICATIONS

The entire disclosure of Japanese Patent Application No. 2024-083196 filed on May 22, 2024, is incorporated herein by reference in its entirety.

### BACKGROUND OF THE INVENTION

### Technical Field

The present invention relates to an image forming method and an image forming system. In particular, the present invention relates to an image forming method excellent in blocking resistance and varnish coatability of an image formed on a resin recording medium.

### Description of Related Art

With the increasing variety of recording media in recent years, there is an increasing demand for printing on film that is a resin recording medium.

The resin recording medium is used in a roll-to-roll printing technique. In the roll-to-roll printing, a resin recording medium wound in a roll is passed through a conveyance line provided with processing devices for printing, coating, heat treatment, for example, and is finally wound around a winding roll at the end of the line. The image printed on the resin recording medium by such a process has some problems in durability.

Japanese Unexamined Patent Publication No. 2019-204030 discloses a toner that contains a binding resin that contains constituent moieties derived from polypropylene-based resins. However, the toner has a problem in adhesion to recording media due to the roughness of image surfaces.

To improve the quality and durability of an image printed by the roll-to-roll method using a resin recording medium, a varnish coat may be applied to part of or the entire surface of the image.

The varnish used for varnish coating has low affinity for wax that is included in toner as a release agent. Therefore, the varnish coat tends to be easily repelled when being applied, and the adhesion between the image after coating and the varnish is low.

To solve these problems, Japanese Unexamined Patent Publication No. 2012-078565 uses a varnish that is an overcoat composition containing specific polymerizable compounds to enhance adhesion while suppressing the repelling of the varnish. Furthermore, Japanese Unexamined Patent Publication No. 2012-078565 discloses that it is preferable to use isoparaffin as a release agent for toner when the varnish is used.

Japanese Unexamined Patent Publication No. 2021-036298 discloses a method of producing a printed product. According to the method, a specific amount of wax is distributed on the image surface with a specific uneven distribution degree. JP2021-036298A describes that, when the wax is appropriately unevenly distributed on the image surface, the proportion of toner in contact with the varnish is increased, so that the adhesion between the varnish and the toner image can be increased.

However, according to JP2012-078565A and JP2021-036298A, adhesion between the varnish and the toner image is yet insufficient. Further, a problem of blocking occurs in which an image on one resin recording medium is transferred to the back surface of another resin recording medium when the resin recording media are piled and the image on one recording medium is in contact with the back surface of the other resin recording medium.

The present invention has been made in consideration of the above-described problems and situations. An object of the present invention is to provide an image forming method and an image forming system that realize excellent blocking resistance and varnish coatability of an image formed on a resin recording medium.

To achieve the object, the present inventors studied the causes of the above problems. The present inventors found that the blocking resistance and the varnish coatability of an image formed on a resin recording medium can be increased when (i) an image is formed using a toner containing a specific amount or less of a saturated hydrocarbon compound having 16 to 35 carbon atoms and (ii) the peak density “Spd” of protrusions on the surface of the image is within a specific range.

That is, the above-described problems according to the present invention are solved by the following means.

### SUMMARY OF THE INVENTION

According to an aspect of the present invention, there is provided an electrophotographic image forming method including fixing an electrostatic charge image developing toner onto a resin recording medium to form an image, wherein: a content of a saturated hydrocarbon compound having 16 to 35 carbon atoms is 1,000 ppm by mass or less with respect to a total mass of the electrostatic charge image developing toner, and when an image having an adhesion amount of 4 g/m² or greater is formed on the resin recording medium, a peak density Spd of protrusions on a surface of the image is 5,000 mm² or greater.

By the above-described means of the present invention, an image forming method and an image forming system can form an image having excellent blocking resistance and varnish coatability on a resin recording medium.

Although the mechanism of the effect of the present invention is not clear, the inventors infer the mechanism as follows.

According to the image forming method of the present invention, when an image having an adhesion amount of 4 g/m² or greater is formed on a resin recording medium, the peak density Spd of protrusions on the image surface is made to be 5000 mm⁻² or greater. Thus, when a load is applied, as illustrated in FIG. 1, the peaks Pb of protrusions on the image are more likely to be in contact with the back surface Ra of the resin recording medium R than the smooth surface Pa of the image P (the area other than the peaks on the image). Accordingly, when the recording media having images formed thereon are piled on one another, the back surface Ra of the recording medium R is in point contact with the image P. Thus, it is presumed that the amount of the image transferred to the recording medium R is small.

On the other hand, when the peak density Spd of protrusions is less than 5000 mm⁻² and a load is applied, as illustrated in FIG. 2, the back surface Ra of the recording medium R is likely to be in contact with the smooth surface Pa of the image P (the area other than the peaks). Therefore, when the recording media having images formed thereon are piled on one another, the back surface Ra of the recording medium R is in surface contact with the image P. Thus, it is presumed that the amount of the image transferred to the recording medium R is increased.

However, an image having a high peak density Spd of protrusions has a fractal structure with many peaks (i.e., many irregularities) on its image surface. Therefore, when varnish is applied to the image having a high peak density Spd, the varnish droplets are likely to be repelled and do not spread on the image surface, and the varnish coatability is decreased.

On the other hand, a saturated hydrocarbon compound having 16 to 35 carbon atoms does not have high affinity for varnish. Furthermore, due to the short chain length, the saturated hydrocarbon compound is likely to ooze out on the image surface during heat fixing, cover the image surface, and repel varnish.

The fractal structure, which has a large protrusion peak density Spd and many recesses and projections, easily repels vanish. When the content of the saturated hydrocarbon compound is 1000 ppm by mass or less, repelling of varnish repelling can be restrained for the fractal structure.

Since the saturated hydrocarbon compound having 15 or less carbon atoms has a low molecular weight and a low viscosity, it is easily sublimated and does not cause a problem. Therefore, the content of the saturated hydrocarbon compound having 16 to 35 carbon atoms is defined.

Based on the foregoing, it is presumed that an image formed on a resin recording medium can have both the blocking resistance and the varnish coatability when the peak density Spd of protrusions on the image surface is 5000 mm⁻² or greater and when the content of the saturated hydrocarbon compound having 16 to 35 carbon atoms in toner is 1000 ppm by mass or less.

### BRIEF DESCRIPTION OF THE DRAWINGS

The advantages and features provided by one or greater embodiments of the invention will become more fully understood from the detailed description given hereinafter and the appended drawings which are given by way of illustration only, and thus are not intended as a definition of the limits of the present invention, and wherein:

FIG. 1 is a diagram for explaining the state of the back surface of a recording medium in contact with an image when the peak density Spd of protrusions is equal to or greater than 5000 mm⁻²;

FIG. 2 is a diagram for explaining the state of the back surface of a recording medium in contact with an image when the peak density Spd of protrusions is less than 5000 mm⁻²;

FIG. 3 illustrates an example of the overall configuration of an image forming apparatus according to the present embodiment; and

FIG. 4 illustrates a main control part of the image forming apparatus.

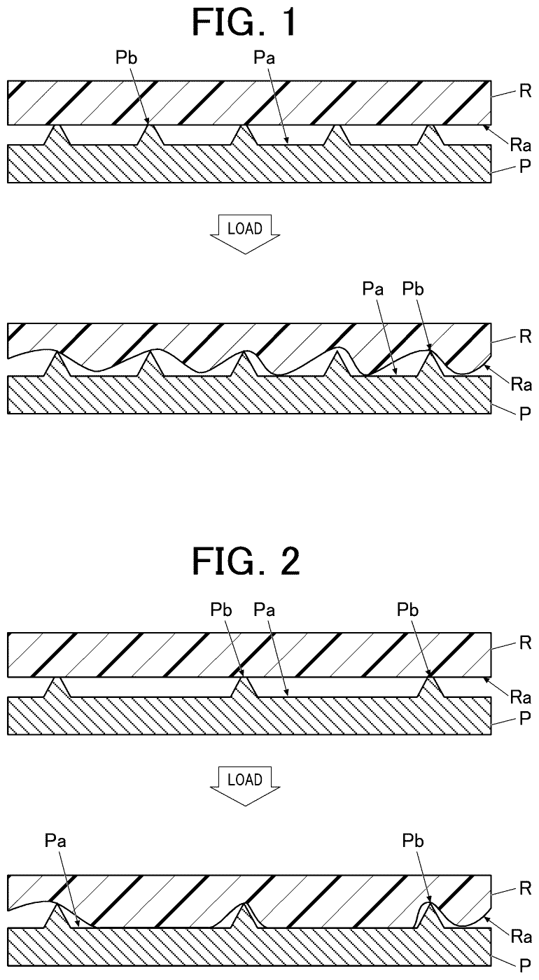

### DETAILED DESCRIPTION

Hereinafter, one or more embodiments of the present invention will be described with reference to the drawings. However, the scope of the invention is not limited to the disclosed embodiments. An image forming method according to the present invention is an electrophotographic image forming method including fixing an electrostatic charge image developing toner to a resin recording medium to form an image. In the image forming method, the content of the saturated hydrocarbon compounds having 16 to 35 carbon atoms is 1000 ppm by mass or less relative to the total weight of the electrostatic charge image developing toner; and when an image having an adhesion amount of 4 g/m 2 or greater is formed on the resin recording medium, the peak density Spd of projections on the image surface is 5000 mm⁻² or greater.

The above features are technical features common to or corresponding to each of the following embodiments.

As an embodiment of the present invention, the content of the saturated hydrocarbon compound is preferably 1 ppm by mass or greater with respect to the total mass of the electrostatic charge image developing toner. When a small amount of the saturated hydrocarbon compound having a short chain length is added, the saturated hydrocarbon compound serves as a crystal nucleating agent, and the crystallization of the crystalline material containing the release agent proceeds. Accordingly, the crystalline material is hardened. Therefore, the heat-resistant storage stability of the toner is improved.

It is preferable that the resin recording medium is a continuous medium from the viewpoint of improving production efficiency and applying the present invention to a roll-to-roll type printing processing technique.

The resin recording medium preferably has a thickness of 75 μm or less. A thicker resin recording medium is less influenced by the temperature and pressure received from the recording medium side during fixing, and fixing failure is more likely to occur. When the thickness of the resin recording medium is 75 μm or less, such thickness covers general-purpose recording media and does not cause fixing failure.

In particular, it is preferable that the resin recording medium is a polyethylene terephthalate film having a thickness of 50 μm from the viewpoint of fixability and adhesiveness.

It is preferable that the electrostatic charge image developing toner contains a binding resin and that the binding resin contains at least an amorphous polyester and a crystalline polyester. Thus, the meltability of the toner is improved, and an image excellent in fixability and adhesiveness is likely to be formed.

The content of the amorphous polyester in the binding resin is preferably in the range of 5 to 80% by mass. When the content of the amorphous polyester is within the above range, the meltability of the resin increases (molecular chains are more likely to be entangled), and the surface roughness Spd can be controlled to be 5000 mm² or greater. As a result, the saturated hydrocarbon compound is easily and effectively precipitated at the time of fixing, and both the improvement of the blocking resistance and the varnish coatability can be achieved.

The polyhydric alcohol component in the amorphous polyester is preferably an aliphatic polyhydric alcohol component or an alicyclic polyhydric alcohol component.

Since the structure of the acyclic aliphatic polyhydric alcohol component is highly flexible (the molecular chains are easily rotated), the meltability of the resin is increased (the molecular chains are easily entangled), and the surface roughness Spd can be easily regulated within the defined range.

Since the acyclic aliphatic polyhydric alcohol component is straight-chained, its molecular structure and polarity are considered to be close to those of the crystalline polyester. Therefore, the saturated hydrocarbon compound is easily and effectively precipitated at the time of fixing, so that blocking resistance and varnish coatability can be achieved.

The polyhydric alcohol component is preferably an acyclic aliphatic polyhydric alcohol having 5 or greater carbon atoms. The structure of the acyclic aliphatic polyhydric alcohol is highly flexible (the molecular chains are easily rotated). Therefore, the meltability of the resin is increased (the molecular chains are easily entangled), and the surface roughness Spd can be easily regulated within the defined range. Further, since the molecular structure of the acyclic aliphatic polyhydric alcohol component is straight-chained, its molecular structure and polarity are considered to be close to those of the crystalline polyester.

Therefore, the saturated hydrocarbon compound is easily and effectively precipitated at the time of fixing, so that blocking resistance and varnish coatability can be achieved.

Furthermore, when the number of carbon atoms in the acyclic aliphatic polyhydric alcohol is 5 or greater, the hydrophobicity of the resin increases. Accordingly, the hydrophobic interaction between the toner and the resin recording medium increases, so that the image is firmly adhered to the recording medium.

It is preferable that the binding resin contains an amorphous resin having a weight-average molecular weight in the range of 50,000 to 500,000 to regulate the peak density SPd to a small value. Since the amorphous resin having a weight average molecular weight of 50,000 to 500,000 is highly elastic, it causes elastic recovery of the resin after the toner is separated from the belt in image formation. Accordingly, the number of pulled traces (protrusions) formed on the image due to separation can be reduced, and the peak density Spd of the protrusions can be a small value.

It is preferable that the image forming method of the present invention includes a step of applying varnish to improve image quality and durability and to obtain the effect of the present invention.

The image forming system of the present invention is an electrophotographic image forming system that includes an electrostatic image developing toner and a means for fixing the electrostatic image developing toner to form an image. The content of the saturated hydrocarbon compounds having 16 to 35 carbon atoms in the toner is 1,000 ppm by mass or less with respect to the total mass of the electrostatic image developing toner. When an image having an adhesion amount of 4 g/m² or greater is formed on the resin recording medium, the peak density Spd of protrusions on the image is 5,000 mm⁻² or greater. Thus, both blocking resistance and vanish coatability of an image formed on a resin recording medium can be achieved.

Hereinafter, the present invention, constituent elements of the present invention, and embodiments and modes for carrying out the present invention will be described. In the present description, “to” between two numerical values is used to indicate a range of values including the two numerical values as a lower limit value and an upper limit value.

### 1. Outline of Image Forming Method of the Present Invention

The image forming method according to the present invention is an electrophotographic image forming method including fixing an electrostatic charge image developing toner to a resin recording medium to form an image. In the image forming method, the content of the saturated hydrocarbon compounds having 16 to 35 carbon atoms is 1,000 ppm by mass or less relative to the total weight of the electrostatic charge image developing toner; and when an image having an adhesion amount of 4 g/m² or greater is formed on the resin recording medium, the peak density Spd of protrusions on the image surface is 5,000 mm⁻² or greater.

Hereinafter, “electrostatic charge image development toner” is also simply referred to as “toner”. The “saturated hydrocarbon compound having 16 to 35 carbon atoms” is also simply referred to as “C16-35 saturated compound”.

The toner includes toner particles. Each toner particle includes a toner base particle and an external additive disposed on the surface of the toner base particle.

The “toner base particle” is the base particle of the “toner particle”. The “toner base particle” of the present invention contains at least binding resin and may contain other constituent components, such as a colorant, a release agent (wax), and a charge control agent, if necessary. The toner base particles to which an external additive is added are referred to as “toner particles”. The “toner” refers to an aggregate of the toner particles.

A “toner image” refers to a state of the toner aggregated as an image.

### <Resin Recording Medium>

The resin recording medium used in the present invention is transparent and flexible and is made of a resin, such as polyethylene terephthalate (PET), polypropylene (PP), polyethylene (PE), or polyolefin (PO).

The resin recording medium may have a single layer or multiple layers in which two or greater layers of resin recording media are united by adhesive layers. The surface of the resin recording medium may not be treated with corona treatment, plasma treatment, or the like, but is preferably treated with corona treatment, plasma treatment, or the like from the viewpoint of adhesion.

It is preferable that the resin recording medium is a continuous medium from the viewpoint of improving production efficiency and applying the present invention to a roll-to-roll type printing processing technique.

Examples of the continuous medium include continuous forms and roll sheets.

The thickness of the resin recording medium is preferably 75 μm or less to cover general-purpose recording media and to obtain an image without fixing failure. The thickness of the resin recording medium is more preferably within a range of 50 to 75 μm.

In particular, in the present invention, the resin recording medium is preferably a polyethylene terephthalate film having a thickness of 50 μm from the viewpoint of fixability and adhesiveness.

### <Peak Density Spd of Protrusions>

In the present invention, the peak density Spd is used as the roughness of the image surface by the following reason.

The surface roughness can be broadly classified into two categories, “line roughness” and “surface roughness”. Regarding line roughness, a contour curve is two-dimensional information, whereas regarding surface roughness, three dimensional information is obtained. Therefore, surface roughness includes much more information. A measuring machine, filter processing, measurement conditions, and so forth need to be determined, based on roughness information to be obtained.

The surface of a printed image is formed of many protrusions and recesses. To control the rough state, the inventors considered it preferable to use “surface roughness” that consists of three-dimensional information and that includes a large amount of information, rather than “line roughness” that tends to include variations in measurement results depending on the measured part and the scanning direction.

There are several main parameters for the “surface roughness”. Specifically, the surface roughness can be classified into a height-direction parameter, a spatial parameter, a composite parameter, a function-related parameter, and a shape parameter. When an actual image is three-dimensionally observed using an optical microscope or a scanning electron microscope, the size and distribution of the irregularities can be visually determined.

Herein, the number of contact points between the protrusions on the image and the back surface of the recording medium affects the blocking property, which is a problem to be solved. Further, the number of protrusions on the image affects wetting and spreading of varnish and thereby affects varnish coatability. Therefore, regarding the blocking property and the varnish coatability, it was found that the number of protrusions forming the image surface is appropriate as a roughness parameter that indicates the contact state between the image surface and an object in contact with the image surface.

The number of protrusions is expressed by “peak density Spd”. The peak density Spd refers to the number of peaks of protrusions per unit area.

According to the image forming method of the present invention, when an image having an adhesion amount of 4 g/m² or greater is formed on the resin recording medium, the peak density Spd of protrusions on the image surface is 5,000 mm⁻² or greater. In particular, when an image having an adhesion amount of 4 g/m² or greater is formed on a polyethylene terephthalate film having a thickness of 50 μm as the resin recording medium, it is preferable that the peak density Spd of the peaks on the surfaces of the image are 5,000 mm⁻² or greater.

The peak density Spd is preferably within a range of 10,000 to 100,000 mm⁻² from the viewpoint that both blocking resistance and varnishing coatability are easily achieved.

The peak density Spd represents the number of peaks of protrusions per unit area. Only the peaks greater than 5% of the maximum amplitude of the contour curved surface of the image are counted. The number of peaks is divided by the projected area of the contour curved surface to obtain the peak density Spd. The peak density Spd can be measured by a non-contact type surface roughness measuring instrument.

### (Measurement Method)

A recording medium having an image formed thereon is placed on a stage of a laser microscope (VKX-250 manufactured by Keyence Corporation) such that the toner layer side faces upward. The surface of the toner layer is focused with a 10×lens (1425 μm×1069 μm), and surface filter processing is performed on the original front surface to obtain the primary surface and the measurement surface. The primary surface is a reference surface serving as a reference corresponding to the measurement surface.

An evaluation region (entire region: 1425 μm×1425 μm) is designated on the measurement surface, and the surface shape of the reference surface corresponding to the measurement surface is corrected (waviness is removed). The filter is set as follows: Gaussian setting, S-filter, F-operation, no L-filter, and correction of terminal curing are turned on. Then the peak density Spd of protrusions is measured. The peak density Spd is measured 10 times while randomly changing the observation regions, and the average of the measured peak densities Spd is calculated.

In measuring the Spd with the laser microscope, the peaks greater than 5% of the maximum amplitude (maximum height of protrusions) of the curved contour surface are counted. When the measurement is performed by a means other than the laser microscope, the peaks smaller than 5% (the lower limit) are omitted.

To obtain the peak density Spd of protrusions on the image surface within the above-mentioned range, the following methods (i) and (ii) can be used, for example.

(i) The polyhydric alcohol component of the amorphous polyester contained in the toner base particles is a linear or alicyclic polyhydric alcohol component. That is, it is preferable that the polyhydric alcohol component does not have a structural unit derived from bisphenol A or a bisphenol A derivative.

When the polyhydric alcohol component of the amorphous polyester is a linear or alicyclic polyhydric alcohol component, the amorphous polyester has a flexible structure. With a flexible structure, it is presumed that the meltability of the resin increases (the viscosity decreases); the molten resin is likely to be pulled after being separated from the belt in image formation; and many pulled forms (protrusions) are formed on the image by the separation. As a result, the peak density Spd of protrusions on the obtained image surface is increased.

(ii) As the polyhydric alcohol component in (i), an amorphous polyester formed from a linear or alicyclic polyhydric alcohol is used; and a highly elastic component is added to the toner base particles. The highly elastic component is, for example, an amorphous resin having a weight-average molecular weight within a range of 50,000 to 500,000 (high molecular weight body).

When the toner base particles contain an amorphous resin having a weight-average molecular weight in the range of 50,000 to 500,000, the peak density SPd of protrusions on the image surface can be controlled to be low. Since the amorphous resin having a weight average molecular weight of 50,000 to 500,000 is highly elastic, it causes elastic recovery of the resin after the toner is separated from the belt in image formation. Accordingly, the number of pulled traces (protrusions) formed on the image due to separation can be reduced, and the peak density Spd of protrusions is controlled to be low.

### <Saturated Hydrocarbon Compounds Having 16 to 35 Carbon Atoms (C16-35 Saturated Compounds)>

The content of the saturated hydrocarbon compound having 16 to 35 carbon atoms in the toner of the present invention is 1,000 ppm by mass or less with respect to the total mass of the toner. The content of the C16-C35 compound may be 0 ppm by mass with respect to the total mass of the toner. The content of the C16-35 compound is preferably 1 ppm by mass or greater with respect to the total mass of the toner.

The reason for focusing on the C16-35 compound in the present invention is as follows.

As described above, when varnish is applied to an image having a high peak density Spd, the image surface has many peaks, namely has a fractal structure including many protrusions and recesses. Therefore, the varnish droplets are likely to be repelled and do not spread on the image surface, so that the varnish coatability is decreased.

On the other hand, the C16-35 saturated compound does not have a high affinity for varnish. Furthermore, due to the short chain length, the C16-35 saturated compound oozes out onto the image surface at the time of heat fixing and covers the image surface to repel the varnish. If the content of the C16-35 saturated compound in the toner is excessive and the image surface is densely covered with the C16-35 saturated compound, it is considered that the varnish adhesion is decreased.

To reduce repelling of varnish, the content of the C16-35 saturated compound is set to be equal to or less than 1,000 ppm by mass with respect to the total mass of the toner. The content of the C16-35 saturated compound is preferably 1 ppm by mass or greater and in the range of 10 to 950 ppm by mass with respect to the total mass of the toner in view of the heat-resistant storage stability of the toner. The “total mass of the toner” refers to the mass including the toner base particles and the external additive.

If the number of carbon atoms is 15 or less, the compound has a low molecular weight and a low viscosity, so that the component is easily sublimated. Further, if the number of carbon atoms is equal to or greater than 36, the compound is a long-chain hydrocarbon saturated compound, and it is difficult to arrange the compound on the image surface. Therefore, the content of the 16-35 saturated compound is defined as described above.

Since the C16-35 saturated compounds have a wax-like structure, the C16-35 saturated compounds also have an effect of enhancing the toner releasability from a fixing member to a certain extent.

### 2. Toner

Hereinafter, a structure of the toner will be described.

The toner includes the toner base particles and the external additive. The content of the C16-35 saturated compound in the toner is 10,000 ppm by mass or less with respect to the total mass of the toner.

The toner base particles may contain constituent components, such as a binding resin, a release agent, a colorant, and a charge control agent, if necessary.

### [Toner Base Particles]

### <Binding Resin>

The toner base particles according to the present invention preferably contain a binding resin. Since the toner base particles contain a binding resin, the toner can be fixed on the resin recording medium.

The binding resin according to the present invention preferably contains at least an amorphous polyester and a crystalline polyester. In addition to the amorphous polyester and the crystalline polyester, the binding resin according to the present invention preferably contains an amorphous resin having a weight average molecular weight in the range of 50,000 to 500,000. If necessary, as the binding resin, an amorphous resin and a crystalline resin other than the amorphous polyester and the crystalline polyester may be contained.

### (Analysis Method of Resin Composition)

The composition of each resin contained in the toner base particles can be analyzed by, for example, pyrolysis gas chromatography/mass spectrometry (GC/MS).

Specifically, the amount can be determined by the standard addition method using a column and a detector that have been confirmed to be able to detect a monomer having a specific structure.

An example of detailed thermal decomposition conditions and GC/MS measurement conditions is given below.

### (Pyrolysis Conditions)

Measurement device: PY 2020iD (manufactured by Frontier Laboratories Ltd.)
Weight of measurement: 0.1 mg
Heating temperature: 550° C.
Heating time: 0.5 minutes

### (Measurement Conditions of GC/MS)

Measuring device: QP2010 (manufactured by Shimadzu Corporation)
Column: UltraALLOY-5 (inside diameter: 0.25 mm, length: 30 m, thickness: 0.25 μm, manufactured by Frontier Laboratories Ltd.)
Temperature increase range: 40° C. to 320° C. (held at 320° C.)
Temperature increase rate: 20° C./min

### (Amorphous Resin)

In the present invention, the term “exhibiting amorphousness” means that the resin has a glass transition temperature (Tg) but does not have a melting point, that is, a clear endothermic peak during temperature increase in an endothermic curve obtained by differential scanning calorimetry (DSC). The clear endothermic peak refers to an endothermic peak having a half width of 15° C. or less in an endothermic curve when the temperature is increased at a temperature increase rate of 10° C./min.

### <Amorphous Polyester>

From the viewpoint of low-temperature fixability, the toner base particles according to the present invention preferably contain an amorphous polyester.

The “amorphous polyester” refers to a polyester that exhibits amorphousness among polyesters obtained by a polycondensation reaction of a divalent or higher-valent carboxylic acid (polycarboxylic acid) monomer and a divalent or higher-valent alcohol (polyhydric alcohol) monomer. The amorphous polyester can be synthesized by polycondensation (esterification) of the aforementioned polycarboxylic acid monomer and polyhydric alcohol monomer using a known esterification catalyst.

The polycarboxylic acid is a compound containing two or more carboxy groups in one molecule.

Examples of the polycarboxylic acid include phthalic acid, isophthalic acid, terephthalic acid, trimellitic acid, naphthalene-2,6-dicarboxylic acid, malonic acid, mesaconic acid, dimethyl isophthalate, fumaric acid, dodecenyl succinic acid, and 1,10-dodecanedicarboxylic acid. Among these, dimethyl isophthalate, terephthalic acid, dodecenylsuccinic acid, and trimellitic acid are preferable.

These may be contained alone or in combination of two or more.

The polyhydric alcohol is a compound having two or more hydroxy groups in one molecule.

Examples of the polyhydric alcohol include: dihydric alcohols such as ethylene glycol, propylene glycol, butanediol, diethylene glycol, pentanediol, neopentyl glycol, hexanediol, heptanediol, cyclohexanediol, octanediol, decanediol, and dodecanediol; tri- or more valent polyols such as glycerin, pentaerythritol, hexamethylol melamine, hexaethylolmelamine, tetramethylolbenzoguanamine, tetraethylolbenzoguanamine; the ester compounds thereof; and hydroxycarboxylic acid derivatives.

These may be contained alone or in combination of two or more.

From the viewpoint that bisphenols can be esterified similarly to alcohols, in the present invention, the “polyhydric alcohol” includes bisphenol A or a bisphenol A derivative. Examples of bisphenol A derivatives include an ethylene oxide adduct of bisphenol A (BPA-EO) and a propylene oxide adduct of bisphenol A (BPA-PO).

Among these, the polyhydric alcohol is preferably an aliphatic polyhydric alcohol or an alicyclic polyhydric alcohol. In particular, the polyhydric alcohol is preferably an acyclic aliphatic polyhydric alcohol having 5 or more carbon atoms, and most preferably an aliphatic polyhydric alcohol having 5 to 7 carbon atoms.

Since the aliphatic polyhydric alcohol having 5 to 7 carbon atoms has a relatively small volume (bulkiness), it is easy to make the inter-bond distance of the ester bond uniform in the polyester obtained by synthesis. Furthermore, a portion where the density of ester groups is locally high is less likely to be formed. Specifically, it is thought that a hydrophilic moiety derived from an ester bond and a hydrophobic moiety derived from a hydrocarbon group are appropriately dispersed, thereby suppressing charge leakage.

In particular, an aliphatic polyhydric alcohol having 5 to 7 carbon atoms is less bulky than bisphenol A or a bisphenol A derivative. Therefore, it is considered that the aliphatic polyhydric alcohol having 5 to 7 carbon atoms can reduce charge leakage as compared with bisphenol A or a bisphenol A derivative.

Examples of the aliphatic polyhydric alcohol having the carbon number of 5 to 7 include pentanediol, neopentyl glycol, hexanediol, heptanediol and cyclohexanediol.

From the viewpoint of suppressing charge leakage, the proportion of bisphenol A or a bisphenol A derivative in the polyhydric alcohol is preferably low.

In the present invention, the content of the structural units derived from bisphenol A or a bisphenol A derivative is 10 mol % or less based on the total moles of the structural units derived from the polyhydric alcohols. It is considered that this can suppress charge leakage and uneven density of an image to be formed.

The content of the structural units derived from bisphenol A or a bisphenol A derivative with respect to the total moles of the structural units derived from the polyhydric alcohol is preferably lower. Specifically, the content is preferably 5 mol % or less, and more preferably 1 mol % or less.

The structural units derived from a polyhydric alcohol may not contain a structural unit derived from bisphenol A or a bisphenol A derivative at all.

Examples of the esterification catalyst include alkali metal compounds such as sodium and lithium; alkaline earth metal compounds such as magnesium and calcium; metal compounds such as aluminum, zinc, manganese, antimony, titanium, tin, zirconium, and germanium; phosphorous acid compounds; phosphoric acid compounds; and amine compounds.

The polymerization temperature is not particularly limited and is, for example, preferably within the range of 150 to 250° C. The polymerization time is not particularly limited and is, for example, preferably in the range of 0.5 to 10 hours. During the polymerization, the pressure in the reaction system may be reduced as necessary.

The content of the amorphous polyester is preferably in the range of 5 to 80% by mass and more preferably in the range of 10 to 50% by mass with respect to the total mass of the binding resin.

In addition, the content of the amorphous polyester is preferably 10% by mass or more, and more preferably 40% by mass or more with respect to the total mass of the toner base particles.

### <Hybrid Amorphous Polyester>

The amorphous polyester may be a hybrid crystalline polyester in which amorphous polyester polymerized segments and amorphous polymerized segments other than the amorphous polyester are chemically bonded with each other.

<Amorphous Resin Having a Weight-Average Molecular Weight within a Range of 50,000 to 500,000>

The binding resin preferably contains an amorphous resin in addition to at least the amorphous polyester and the crystalline polyester.

The amorphous resin may have a weight average molecular weight (Mw) of 10,000 to 40,000 or may have a weight average molecular weight within a range of 50,000 to 500,000 (high-molecular-weight body). In the present invention, the toner preferably contains, as the binding resin, both the amorphous resin having a weight average molecular weight of 10,000 to 40,000 and the amorphous resin that is a high-molecular-weight body.

The content of the amorphous resin having a weight-average molecular weight of 10,000 to 40,000 is preferably in the range of 1 to 90% by mass based on the total mass of the binding resin.

The content of the high-molecular-weight amorphous resin is preferably in the range of 0 to 1% by mass based on the total amount of the binding resin.

The weight-average molecular weight of the amorphous resin having a weight-average molecular weight of 10,000 to 40,000 and the high molecular weight amorphous resin can be measured in the same manner as the weight-average molecular weight of the crystalline resin, which is described later.

Preferable examples of the amorphous resin having a weight-average molecular weight of 10,000 to 40,000 and the high-molecular-weight amorphous resin include a vinyl resin, a urethane resin, and a urea resin. In the present invention, the amorphous resin having a weight-average molecular weight of 10,000 to 40,000 and the high-molecular-weight amorphous resin are preferably vinyl resin.

The vinyl resin is a resin obtained by polymerization using at least a vinyl-based monomer.

Examples of the amorphous vinyl resin include an acrylic resin and a styrene-acrylic resin. Among these, as the amorphous vinyl resin, a styrene-acrylic resin formed using a styrene-based monomer and a (meth) acrylic acid ester-based monomer are preferable.

Examples of the styrene-based monomer and the (meth)acrylic acid ester-based monomer capable of forming the styrene-acrylic resin are shown below. However, those usable for forming the styrene-acrylic resin used in the present invention are not limited to those shown below.

### <Styrene-Based Monomer>

Examples of the styrene-based monomer include styrene, o-methylstyrene, m-methylstyrene, p-methylstyrene, α-methylstyrene, p-phenylstyrene, p-ethylstyrene, 2,4-dimethylstyrene, p-tert-butylstyrene, p-n-hexylstyrene, p-n-octylstyrene, p-n-nonylstyrene, p-n-decylstyrene, p-n-dodecylstyrene, and derivatives thereof. These styrene-based monomers can be used alone or in combination of two or more.

### <(Meth)Acrylic Acid Ester Monomer>

Examples of the (meth)acrylate ester-based monomer include: acrylic acid ester monomers such as methyl acrylate, ethyl acrylate, isopropyl acrylate, n-butyl acrylate, t-butyl acrylate, isobutyl acrylate, n-octyl acrylate, 2-ethylhexyl acrylate, stearyl acrylate, lauryl acrylate, and phenyl acrylate; and methacrylic acid esters such as methyl methacrylate, ethyl methacrylate, n-butyl methacrylate, isopropyl methacrylate, isobutyl methacrylate, t-butyl methacrylate, n-octyl methacrylate, 2-ethylhexyl methacrylate, stearyl methacrylate, lauryl methacrylate, phenyl methacrylate, diethylaminoethyl methacrylate, and dimethylaminoethyl methacrylate.

The content of the styrene-acrylic resin is preferably 70% by mass or greater with respect to the total amount of the binding resin. Within this range, chargeability can be sufficiently improved.

As the polymerizable monomer, a third polymerizable monomer can also be used in addition to the above-described polymerizable monomers. Examples of the third polymerizable monomer include an acid monomer such as acrylic acid, methacrylic acid, maleic anhydride, and vinylacetic acid. Examples of the third polymerizable monomer also include acrylamide, methacrylamide, acrylonitrile, ethylene, propylene, butylene vinyl chloride, N-vinylpyrrolidone, and butadiene.

Further, as the third polymerizable monomer, a polyfunctional vinyl monomer may be used. Examples of the polyfunctional vinyl monomer include: diacrylates such as ethylene glycol, propylene glycol, butylene glycol, and hexylene glycol; and dimethacrylates and trimethacrylates of tertiary and higher alcohols such as divinylbenzene, pentaerythritol, and trimethylolpropane.

### <Glass Transition Temperature>

From the viewpoint of achieving both sufficient low-temperature fixability and heat-resistant storage property, the glass transition temperature (Tg) of the amorphous resin is preferably in a range of 30 to 70° C. and more preferably in a range of 40 to 65° C.

For example, differential scanning calorimetry (DSC measurement) is performed using a differential scanning calorimeter “DSC7000X” (manufactured by Hitachi, Ltd.) and a thermal analyzer controller “AS3/DX” (manufactured by Hitachi, Ltd.). Specifically, 5 mg of a sample is sealed in a sample container having φ6.8 and H2.5 mm (manufactured by HITACHI, Ltd.) for the AL autosampler and a cover for the AL autosampler (manufactured by HITACHI, Ltd.). This is placed in a sample holder of the “AS3/DX”, and the temperature is changed in the order of temperature increase, temperature decrease, and temperature increase. In the first and second temperature increases, the temperature is increased from 0° C. to 150° C. at a temperature increase rate of 10° C./min, and the temperature is held at 150° C. for 1 minute. In the temperature decrease, the temperature is decreased from 150° C. to 0° C. at a temperature decrease rate of 10° C./min, and the temperature is held at 0° C. for 1 minute. The baseline shift in the measurement curve obtained in the second heating is determined. The intersection of an extended line of the baseline before the shift and a tangent line indicating the maximum inclination of the shifted portion of the baseline is defined as the glass transition temperature (Tg). An empty aluminum pan is used for a reference.

### (Crystalline Resin)

The toner base particles according to the present invention preferably contain a crystalline resin. When the crystalline resin is contained, the crystalline portion is melted when the temperature exceeds a melting point of the crystalline resin, and the crystalline resin and the amorphous resin are compatibilized with each other, thus improving low-temperature fixability.

In the present invention, the expression “exhibiting crystallinity” means that, in an endothermic curve obtained by DSC (differential scanning calorimetry), the curve does not show a stepwise endothermic change but has a clear endothermic peak at the time of temperature increase, that is, a melting point. The clear endothermic peak refers to a peak having a half value width of 15° C. or less in an endothermic curve when the temperature is increased at a temperature increase rate of 10° C./min.

As the crystalline resin, known crystalline resins, for example, crystalline polyester and crystalline polyurethane are preferably used. In particular, crystalline polyester is preferable from the viewpoints of sharp melting property during melting and compatibility with a binding resin. That is, the moiety having a crystal structure preferably contains a crystalline polyester.

The content of the crystalline polyester is preferably within a range of 0.1 to 15% by mass with respect to the total mass of the binding resin.

### <Crystalline Polyester>

The “crystalline polyester” refers to a polyester exhibiting crystallinity among known polyesters obtained by a polycondensation reaction between a carboxylic acid having a valency of 2 or more (polyvalent carboxylic acid) and an alcohol having a valency of 2 or more (polyhydric alcohol).

The crystalline polyester preferably has a structural unit derived from an aliphatic diol and a structural unit derived from an aliphatic carboxylic acid. In addition, the crystalline polyester preferably has only a structural unit derived from an aliphatic diol and a structural unit derived from an aliphatic carboxylic acid.

The number of carbon atoms of the aliphatic diol or the aliphatic carboxylic acid is more preferably in a range of 6 to 10. When the crystalline polyester has a structure which is not relatively bulky, it is considered that the ester group can be prevented from being locally present at a high density, which prevents leakage of charges.

The polycarboxylic acid is a compound containing two or more carboxy groups in one molecule.

Examples of the polyvalent carboxylic acids include saturated aliphatic dicarboxylic acids such as oxalic acid, malonic acid, succinic acid, adipic acid, sebacic acid, azelaic acid, N-dodecylsuccinic acid, nonanedicarboxylic acid, decanedicarboxylic acid, undecanedicarboxylic acid, dodecanedicarboxylic acid (dodecanedioic acid), and tetradecanedicarboxylic acid (tetradecanedioic acid); alicyclic dicarboxylic acids such as cyclohexanedicarboxylic acid; aromatic dicarboxylic acids such as phthalic acid, isophthalic acid, and terephthalic acid; polycarboxylic acid having 3 or more valences such as trimellitic acid, and pyromellitic acid; and anhydrides of these carboxylic acid compounds. Examples of the polyvalent carboxylic acids further include alkyl esters having 1 to 3 carbon atoms. The crystalline polyester may contain only one of them, or may contain two or more of them.

The polyhydric alcohol is a compound having two or more hydroxy groups in one molecule.

Examples of the polyhydric alcohol include aliphatic diols such as 1,2-propanediol, 1,3-propanediol, 1,4-butanediol, 1,5-pentanediol, 1,6-hexanediol, 1,7-heptanediol, 1,8-octanediol, 1,9-nonanediol, dodecanediol, neopentyl glycol, and 1,4-butenediol; and polyhydric alcohols having 3 or more valences such as glycerin, pentaerythritol, trimethylolpropane, and sorbitol. The crystalline polyester may contain only one of them, or may contain two or more of them.

A method for synthesizing the crystalline polyester is not particularly limited. The polyester resin can be synthesized by polycondensation (esterification) of the above-described polyhydric alcohol component and polycarboxylic acid component using a known esterification catalyst.

The ratio between the polyhydric alcohol component and the polycarboxylic acid component is not particularly limited. For example, the equivalent ratio of hydroxy groups in the polyhydric alcohol component to carboxy groups in the polycarboxylic acid component is preferably in a range of 1.5/1 to 1/1.5, and more preferably in a range of 1.2/1 to 1/1.2.

Examples of the catalyst that can be used in the synthesis of the crystalline polyester include compounds of alkali metals such as sodium and lithium; compounds of alkaline earth metals such as magnesium and calcium; compounds of metals such as aluminum, zinc, manganese, antimony, titanium, tin, zirconium, and germanium; phosphite compounds; phosphate compounds; and amine compounds.

Specifically, examples of the tin compound include dibutyltin oxide, tin octylate, tin dioctylate, and the salts thereof.

Examples of the titanium compound include titanium alkoxides such as tetra-n-butyl titanate, tetraisopropyl titanate, tetramethyl titanate, and tetrastearyl titanate; titanium acylates such as polyhydroxy titanium stearate; and titanium chelates such as titanium tetraacetylacetonate, titanium lactate, and titanium triethanolaminate.

Examples of the germanium compound include germanium dioxide.

Examples of the aluminum compound include oxides such as polyaluminum hydroxide, aluminum alkoxide, and tributyl aluminate.

One of these may be used alone, or two or more of these may be used in combination.

The polymerization temperature and the polymerization time are not particularly limited, and the pressure in the reaction system may be reduced as necessary during the polymerization.

### <Melting Point>

From the viewpoint of low-temperature fixability and hot offset resistance, the melting point (Tm) of the crystalline resin is preferably in a range of 55 to 90° C., and more preferably in a range of 60 to 85° C. The melting point of the crystalline resin can be controlled by controlling its resin composition.

When the crystalline resin is a crystalline polyester, the melting point of the crystalline polyester is preferably 75° C. or lower.

The melting point (Tm) is a peak top temperature in the endothermic peak, and can be measured by DSC (differential scanning calorimetry).

For example, differential scanning calorimetry (DSC measurement) is performed using a differential scanning calorimeter “DSC7000X” (manufactured by Hitachi, Ltd.) and a thermal analyzer controller “AS3/DX” (manufactured by Hitachi, Ltd.). Specifically, 5 mg of a sample is sealed in a sample container having φ6.8 and H2.5 mm (manufactured by HITACHI, Ltd.) for the AL autosampler and a cover for the AL autosampler (manufactured by HITACHI, Ltd.). This is placed in a sample holder of the “AS3/DX”, and the temperature is changed in the order of temperature increase, temperature decrease, and temperature increase. In the first and second temperature increases, the temperature is increased from 0° C. to 150° C. at a temperature increase rate of 10° C./min, and the temperature is held at 150° C. for 1 minute. In the temperature decrease, the temperature is decreased from 150° C. to 0° C. at a temperature decrease rate of 10° C./min, and the temperature is held at 0° C. for 1 minute. The temperature at the top of the endothermic peak in an endothermic curve obtained in the second heating is measured as the melting point.

### <Weight-Average Molecular Weight>

The weight average molecular weight of the crystalline resin is not particularly limited. From the viewpoint of tacking suppression and low-temperature fixability, the weight average molecular weight is preferably in a range of 1,000 to 29,000, more preferably in a range of 1,000 to 20,000, and further preferably in a range of 1,000 to 15,000.

The weight average molecular weight of the crystalline resin can be measured by the following method.

For example, an apparatus of gel permeation chromatography “HLC 8320GPC” (manufactured by Tosoh Corp.), in which one column “TSK gel guard column SuperHZ-L”, and three columns “TSK gel Super HZM-M” (all manufactured by Tosoh Corp.) are connected, is used.

The columns (TSK-) are stabilized at 40° C., and tetrahydrofuran (THF) as a carrier-solvent is allowed to flow through the columns at the same temperature at a flow rate of 0.35 mL/min. THF solution of the measurement sample (resin) adjusted to have a sample concentration of 1 mg/mL is treated with a roll mill at a room temperature for 10 minutes. The solution is treated with a membrane filter having a pore size of 0.2 μm to obtain a sample solution. The sample solution (10 μL) is injected into the apparatus together with the carrier solvent, and the measurement is performed using a refractive index detector (RI detector).

A calibration curve is drawn using polystyrene standard samples having a monodisperse molecular weight distribution. The molecular weight distribution of the measurement sample is calculated based on the calibration curve. The calibration curve is drawn by using 10 samples of “Polystylene Standard Sample TSK standard” manufactured by Tosoh Corp.: “A-500”, “F-1”, “F-10”, “F-80”, “F-380”, “A-2500”, “F-4”, “F-40”, “F-128”, and “F-700”. The data collection interval in the sample analysis is 300 ms.

Alternatively, the crystalline resin and the release agent in the toner may be separated from each other as described below, and then the weight average molecular weight of the crystalline resin may be calculated by the above-described measurement method.

### <Separation of Crystalline Resin>

A case where the crystalline resin is crystalline polyester will be described as an example.

First, the toner is dispersed in ethanol, which is a poor solvent for the toner, and this dispersion liquid is heated to a temperature exceeding the melting points of the crystalline polyester and the release agent. In this step, pressure may be applied as necessary. At this point, the crystalline polyester and the release agent at a temperature exceeding the melting point are dissolved in ethanol. Thereafter, a mixture of the crystalline polyester and the release agent can be collected from the toner by performing solid-liquid separation. The crystalline polyester and the release agent can be separated from the toner by subjecting the mixture to molecular weight fractionation.

### <Acid Value of Crystalline Resin>

In light of low-temperature fixability and fold fixability, the acid value of the crystalline polymer is preferably in a range of 9 to 30 mgKOH/g, and more preferably in a range of 15 to 23 mgKOH/g.

The acid value of the crystalline polyester is expressed in mg (mgKOH/g) of potassium hydroxide required for neutralizing carboxy groups present in 1 g of the resin. Specifically, it is determined by the following method in accordance with JIS K0070-1992.

### (1) Preparation of Reagents

### (a) Phenolphthalein Solution

1.0 g of phenolphthalein is dissolved in 90 mL of ethanol (95% by volume), and ion exchange water is added to obtain 100 mL of a phenolphthalein solution.

### (b) Potassium Hydroxide Solution

7 g of special-grade potassium hydroxide is dissolved in 5 mL of ion exchange water, and ethanol (95% by volume) is added thereto to obtain 1 L of the solution. The solution is placed in an alkali-resistant container so as not to be in contact with carbon dioxide gas or the like, left to stand for 3 days, and then filtered to obtain a potassium hydroxide solution. The obtained potassium hydroxide solution is stored in an alkali-resistant container.

### (c) Factor of Potassium Hydroxide Solution

25 mL of 0.1 mol/L hydrochloride solution is placed in a conical flask, and several drops of the phenolphthalein solution are added. The solution is then titrated with the potassium hydroxide solution. The factor of the potassium hydroxide solution is determined from the amount of the potassium hydroxide solution required for the neutralization.

### (d) Hydrochloric Acid Solution

The 0.1 mol/L hydrochloride solution to be used is prepared in accordance with JIS K8001-1998.

### (2) Operation

### (a) Main Test

2.0 g of toner is precisely weighed into a 200 mL Erlenmeyer flask, 100 mL of a mixed solution of toluene:ethanol (2:1) is added to the Erlenmeyer flask, and the toner is dissolved over the course of 5 hours. Next, several drops of the phenolphthalein solution are added as an indicator to the Erlenmeyer flask, and titration is performed using the potassium hydroxide solution. Note that the end point of the titration is when the pale red color of the indicator continues for about 30 seconds.

### (b) Blank Test

The same titration as in the above-described main test is performed except that the sample is not used, that is, only the mixed solution of toluene:ethanol (2:1) is used.

(3) The acid value is calculated by substituting the obtained results into the following equation.

A=[(C−D)×f×5.611]/S

In the equation, the symbols and numerals represents as follows.
A: acid value (mgKOH/g)
C: amount (mL) of potassium hydroxide solution added in the main test
D: amount (mL) of the potassium hydroxide solution added in the blank test
f: factor of 0.1 mol/L potassium hydroxide-ethanol solution
5.611: molar mass of potassium hydroxide 56.11 (g/mol)×( 1/10)
S: mass of sample (g)

### <Release Agent>

The release agent is not particularly limited, and examples thereof include various known release agents. The release agent is preferably a wax.

Examples of the release agent, which is a wax, include hydrocarbon waxes such as polyethylene wax, paraffin wax, microcrystalline wax, and Fischer-Tropsch wax; dialkyl ketone waxes containing distearyl ketone; carnauba wax; montan wax; ester waxes containing behenic acid behenate, trimethylolpropane tribehenate, pentaerythritol tetramyristate, pentaerythritol tetrastearate, pentaerythritol tetrabehenate, pentaerythritol diacetate dibehenate, glycerin tribehenate, 1,18-octadecanediol distearate, tristearyl trimellitate, distearyl maleate, or the like; and amide waxes containing ethylenediamine dibehenylamide, and trimellitic acid tristearylamide.

Among these, hydrocarbon waxes are preferable because they have a molecular structure similar to that of the C16-35 saturated compounds and allow the release agent to be compatible with the C16-35 saturated compounds. When the C16-35 saturated compounds are satisfactorily compatible, the C16-35 saturated compounds are finely and uniformly dispersed in the toner base particles, and in fixing, the C16-35 saturated compounds are easily precipitated from the toner base particles along with the wax. Accordingly, the varnish applicability is enhanced.

Preferably, the hydrocarbon wax is microcrystalline wax, for example.

The release agent as a wax may be a C16-35 saturated compound or may be a different hydrocarbon wax having 36 to 76 carbon atoms. Since the amount of the C16-35 saturated compound in the toner base particles is extremely small, it is preferable that the toner base particles contain the C16-35 saturated compound and another release agent and contain both the C16-35 saturated compound and the hydrocarbon wax having 36 to 76 carbon atoms to improve both the varnish-applying property by the C16-35 saturated compound and the releasing property by the release agent.

The hydrocarbon wax preferably has a melting point of 50 to 95° C. When the melting point of the hydrocarbon wax is equal to or higher than 50° C., the hydrocarbon wax exuding from the toner particles is easily crystallized. Accordingly, the toner releasing effect and the abrasion resistance of formed images are enhanced.

When the melting point of the hydrocarbon wax is equal to or lower than 95° C., the hydrocarbon wax is more likely to exude from the toner base particles in fixing. Accordingly, the toner releasing effect and the abrasion resistance of formed images are enhanced. Further, when the melting point of the hydrocarbon wax is equal to or lower than 95° C., the toner base particles are likely to melt during fixing, and the toner can be fixed at a low temperature. From the above viewpoints, it is preferable that the melting point of the hydrocarbon wax (in particular, the hydrocarbon wax having 36 to 76 carbon atoms) be 80 to 90° C.

The content of the release agent is preferably 3 to 20% by mass based on the total mass of the toner base particles.

The content is more preferably 5 to 15% by mass. When the amount of the contained release agent is equal to or greater than 3% by mass, the toner releasability from a fixing section is sufficiently enhanced. When the amount of the contained release agent is equal to or less than 20% by mass, the toner base particles can contain a sufficient amount of binding resin, and the image fixability is sufficiently enhanced.

### <C16-35 Saturated Compound>

The C16-35 saturated compounds, which function as described above, enhance the varnish coatability.

The content of the C16-35 saturated compound is 1,000 ppm by mass or less based on the total mass of the toner. The content of the C16-35 saturated compound may be 0 ppm by mass, but the lower limit value of the content is preferably 1 ppm by mass. In addition, the content of the C16-35 saturated compound is preferably 50 to 950 ppm by mass, more preferably 100 to 900 ppm by mass. When the content of the C16-35 saturated compounds is 1,000 ppm by mass or less, both the varnish coatability and the varnish adhesion can be achieved. The total mass of the toner refers to the total of the mass of the toner base particles and the mass of the external additives.

The content of the C16-35 saturated compounds is determined as follows.

Firstly, separate the C16-35 saturated compounds from the toner by using solvents that dissolve the C16-35 saturated compounds, and perform qualitative analysis of hydrocarbons having 16 to 35 carbon atoms by gas chromatography-mass spectrometry (GC-MC). Then quantify these hydrocarbons using a flame ionization detector as a detector for gas chromatography (GC-FID).

Since the extracts from the toner may contain unsaturated hydrocarbons, polar groups are applied to the unsaturated bonds after the extraction, so that only the saturated hydrocarbons are separated by column separation utilizing the polarity difference.

At this time, some internal standard substances may be added to (dissolved in) the solvent to determine whether the quantification and the pretreatment thereof have been appropriately performed. The concentration of the internal standard substances to be added may be determined based on the amount of C16-35 saturated compounds (the estimated amount of C16-35 saturated compounds obtained by a provisional measurement, for example).

The internal standard substances are preferably saturated hydrocarbon compounds that are not usually contained in the toner. For example, use of N-undecane or N-tridecane allows detection of disappearance of saturated hydrocarbon compounds during the pretreatment due to volatilization and also allows estimation of an elution time of target saturated hydrocarbon compounds during solid-phase extraction or analysis by GC-FID. Furthermore, bicyclohexyl contributes to improving detection accuracy because the elution time of bicyclohexyl is less likely to overlap with that of the C16-35 saturated compounds.

The extraction from the toner can be performed by a known method, such as a solid-liquid extraction method, a centrifugation method after dissolving or swelling of the toner, a Soxhlet extraction method, or a high-speed solvent extraction method. The extraction method may be selected from these methods, based on the predicted number of carbon atoms of the C16-35 saturated compounds and the types of compounds as impurities, such as the binding resin.

Although the solvent used for extraction is not particularly limited, it is preferable to use N-hexane, in which C16-35 saturated compounds are highly soluble. To swell the binding resin, a polar solvent such as dichloromethane and ethanol may also be used depending on the type of the binding resin.

Also, the method for introducing polar groups into unsaturated hydrocarbons contained in the extracts is not particularly limited. The introduction can be performed by epoxidation using metachloroperbenzoic acid (mCPBA), addition of hydrogen halide, addition of water or alcohol using an acid catalyst, derivation to alcohol by oxidation after hydroboration, and so forth. Among these, the epoxidation reaction using mCPBA is preferable because of high reactivity and reaction selectivity. The sufficient reaction can be confirmed by confirming the disappearance of the peak of double bonds by the ¹H-NMR measurement.

The application of polar groups may be omitted if a sufficient detection accuracy is secured, depending on the type of the saturated hydrocarbon or the type of the unsaturated hydrocarbon.

The separation by a polarity difference can be done according to a known method, such as solid-phase extraction or online or offline GC. When a large amount of impurities is expected to be contained, separation by solid-phase extraction is preferable.

It is preferable that the solvent used for the separation by solid phase extraction be N-hexane for both the conditioning and the extraction of saturated hydrocarbons. A polar solvent may also be used depending on the kind of expected impurities. After collecting fractions containing C16-35 saturated compounds, it is preferable to collect fractions by further polarizing the solvent and to confirm, by qualitative analysis such as GC/MS, that saturated hydrocarbon components are not contained.

As the solid phase for solid-phase extraction, a highly polar solid phase used for separation of a normal phase system using a polar interaction can be used.

Examples of the solid phase include silica gel, silica gel activated with a polar substance such as anhydrous sodium sulfate and silver nitrate, diol, cyanopropyl, and magnesium silicate. Of these, silica activated with silver nitrate is preferable. To specifically retain a long-chain N-alkane, alumina is not preferable.

Preferably, the fractions containing saturated hydrocarbons extracted by the solid-phase extraction are concentrated or diluted to a concentration appropriate for qualitative and quantitative analysis by gas chromatography. The concentration can be done by vacuum concentration with an evaporator or concentration with nitrogen airflow. Conditions of concentration are determined such that under the conditions, the internal standard substances do not disappear owing to the concentration of low-boiling-point components.

The fractions after solid-phase extraction are subjected to GC-FID under the following conditions to quantify C16-35 saturated compounds, for example.

### (GC Conditions)

Instrument: GC-2010 Plus manufactured by Shimadzu Corporation
Injection amount: 1 μL, concentration of saturated hydrocarbon: 500 to 1,000 mg/L
Guard column: Restek MXT Siltek (10 m×0.53 mm id)
Column: Restek MTX-1 (15 m×0.25 mm id)×0.1 μm df)
Carrier gas: helium

The elution time of N-alkanes (the number of carbon atoms: 10, 16, 24, 35, and 50) is measured beforehand under the same conditions. Further, only N-hexane is injected in the apparatus beforehand to prepare a blank chromatogram.

To determine a baseline, the blank chromatogram obtained beforehand by measurement with the solvent alone is subtracted from the chromatogram obtained for the toner. It is preferable that the base line be a horizontal line at the lowest point before or after a peak, which is derived from the saturated hydrocarbon compounds. If a horizontal baseline cannot be obtained by subtracting the blank chromatogram owing to column bleeding or the like, the baseline may be horizontally drawn on the lower signal intensity among the compounds having 10 carbon atoms to the compounds having 50 carbon atoms from the elution time of the compound having 10 carbon atoms to the elution time of the compound having 50 carbon atoms.

Next, in the chromatogram, perpendicular lines are drawn at positions corresponding to the elution time of the compound having 16 carbon atoms and the elusion time of the compound having 35 carbon atoms. Then, in the chromatogram above the baseline, the area surrounded by these perpendicular lines is calculated. Peaks not caused by saturated hydrocarbon compounds are excluded from the calculation. From the area, the mass of the C16-35 saturated compounds can be determined. When an internal standard substance is used, the mass of C16-35 saturated compounds can be determined based on the ratio of the area to the area of the compound added as the internal standard substance. The obtained mass of C16-35 saturated compounds is divided by the mass of toner to obtain the amount of C16-35 saturated compounds contained in the toner.

### <Colorant>

The colorant is not particularly limited, and examples thereof include various known dyes and pigments.

Examples of a colorant for obtaining a black toner include carbon blacks such as furnace black and channel black; magnetic materials such as magnetite and ferrite; dyes; and inorganic pigments including nonmagnetic iron oxide.

Examples of the colorant for obtaining a color toner include known dyes and organic pigments.

Examples of the organic pigments include: C.I. Pigment Reds 5, 48:1, 53:1, 57:1, 81:4, 122, 139, 144, 149, 166, 177, 178, 222, 238, and 269; C.I. Pigment Yellows 14, 17, 74, 93, 94, 138, 155, 180, and 185; C.I. Pigment Oranges 31, and 43; and C.I. Pigment Blue 15:3, 60, and 76.

Examples of the dyes include: C.I. Solvent Reds 1, 49, 52, 58, 68, 11, and 122; C.I. Solvent Yellows 19, 44, 77, 79, 81, 82, 93, 98, 103, 104, 112, and 162; and C.I. Solvent Blues 25, 36, 69, 70, 93, and 95.

The colorant for obtaining the toner of each color may be contained alone or in combination of two or more kinds for each color.

The content of the colorant is preferably in the range of 1 to 10% by mass and more preferably in the range of 2 to 8% by mass with respect to the total mass of the binder resin.

### <Charge Control Agent>

Examples of the charge control agent include various known compounds.

The content of the charge control agent is preferably in the range of 0.1 to 5.0% by mass with respect to the total mass of the binding resin.

### [External Additives]

In the toner according to the present invention, an external additive may be further added to the toner base particles. Addition of an external additive can further improve the fluidity, chargeability, and cleanability of the toner.

Examples of the external additive include inorganic oxide fine particles such as silica fine particles, alumina fine particles, and titanium oxide fine particles; inorganic stearate compound fine particles such as aluminum stearate fine particles, and zinc stearate fine particles; and inorganic titanate compound fine particles such as strontium titanate, and zinc titanate. They may be used alone or in combination of two or greater.

From the viewpoint of heat-resistant storage property and environmental stability, these inorganic fine particles are preferably subjected to hydrophobization treatment with a silane coupling agent, a titanium coupling agent, a higher fatty acid, silicone oil or the like.

The total amount of the external additives added is preferably in the range of 0.05 to 5% by mass and more preferably in the range of 0.1 to 3% by mass with respect to the total mass of the toner.

### 3 Physical Properties of Toner

### [Particle Diameter of Toner Particle]

The average particle size of the toner particles is, for example, preferably within a range of 3 to 10 μm, and more preferably within a range of 4 to 8 μm, in terms of a volume-based median diameter (D50).

The average particle diameter of the toner particles can be controlled by controlling the concentration of a coagulant used in the production, the amount of an organic solvent added, a fusion time, the composition of the binder resin, and the like.

When the volume-based median size (D50) is within the above range, a very fine dot image at the 1200 dpi level can be faithfully reproduced.

The volume-based median size (D50) of the toner particles is measured and calculated by using a measurement device in which “Multisizer 3” (manufactured by Beckman Coulter, Inc.) is connected to a computer system equipped with the software for data processing “Software V3.51.

Specifically, first, a toner sample to be measured is added to a surfactant solution to be mixed, diluted with pure water, and then subjected to ultrasonic dispersion to prepare toner particle dispersion. As the surfactant solution, for example, an anionic surfactant such as sodium polyoxyethylene lauryl ether sulfate is suitably used for the purpose of dispersing the toner particles.

The toner particle dispersion is injected into a beaker containing “ISOTONII” (manufactured by Beckman Coulter, Inc.) placed in a sample stand with a pipette until the concentration displayed in the measurement device reaches 6 to 8%. With this concentration, a measurement value can be obtained with high reproducibility.

Next, the number of particles counted, and the aperture diameter of the measurement device are set to 25,000 and 100 μm, respectively. The range of 2 to 60 μm, which is the measurement range of the particle size of the toner particles, is divided into 256 segments, and the frequency value of the particle size of the toner particles is calculated. The particle size of 50% particles from the largest volume integrated fraction is defined as a volume-based median diameter (D50).

### [Average Circularity of Toner Particles]

From the viewpoint of the stability of charging characteristics and low-temperature fixability, the average circularity of the toner particles is preferably in the range of 0.930 to 1.000, and more preferably in the range of 0.950 to 0.995.

When the average circularity is within the above range, both toner transferability and cleaning performance can be achieved, toner chargeability is stable, and a high-quality image can be formed.

The average circularity of the toner particles can be measured using, for example, a flow particle image analyzer “FPIA-3000” (manufactured by Sysmex Corporation).

Specifically, a toner sample to be measured is added to and mixed with a surfactant solution, diluted with pure water, and then subjected to ultrasonic dispersion to prepare a toner particle dispersion. As the surfactant solution, for example, an anionic surfactant such as sodium polyoxyethylene lauryl ether sulfate is suitably used for the purpose of dispersing the toner particles. Then, for example, using a flow-type particle image analyzer “FPIA-3000” (manufactured by Sysmex Corporation), an image is captured at an appropriate density, i.e., an HPF detection number of 3,000 to 10,000, in a measurement condition of the HPF (high magnification imaging) mode.

The circularity of each of the toner particles is calculated using the following equation. Next, the average circularity is calculated by adding the circularity of each toner particle and dividing the sum by the total number of toner particles. When the number of HPF detections is within the above range, high reproducibility is obtained.

Circularity=(Perimeter of circle having the same projected area as particle image)/(Perimeter of particle projection image)

### [Glass Transition Temperature of Toner]

From the viewpoint of achieving both sufficient low-temperature fixability and heat-resistant storage property, the glass transition temperature (Tg) of the toner is preferably in a range of 15 to 40° C. and more preferably in a range of 20 to 35° C. The glass transition temperature can be measured by the above-described method.

### [Core-Shell Structure]

The toner base particles may have a multilayer structure. Examples of the multilayer structure include a core-shell structure including a core particle and a shell layer covering the surface of the core particle.

The shell layer may not cover the entire surface of the core particle, and the core particle may be partially exposed. The cross section of the core-shell structure can be confirmed by a known observation means such as a transmission electron microscope (TEM) or a scanning probe microscope (SPM).

When the toner base particles have a core-shell structure, the core particle and the shell layer may have different properties in glass transition temperature, melting point, hardness, and the like, depending on the purpose. For example, core particles containing a binding resin, a coloring agent, a release agent, and the like and having a relatively low glass transition temperature (Tg) are prepared. Then, a resin having a relatively high glass transition temperature (Tg) is aggregated and fused with the core particles to form shell layers. The shell layers preferably contain an amorphous resin. Such a configuration allows for both low-temperature fixability and heat-resistant storage property. In addition, satisfactory charge retention performance is obtained.

### 4. Method of Producing Toner

The toner can be produced in the same manner as a known toner by a pulverization method, an emulsion polymerization aggregation method, an emulsion aggregation method, a suspension polymerization method, or a dissolution suspension method, for example.

Among these, the pulverization method, the emulsion polymerization aggregation method, the emulsion aggregation method, or the suspension polymerization method is preferable, and the pulverization method or the emulsion polymerization aggregation method is more preferable.

In the emulsion aggregation method, first, following are mixed: an aqueous dispersion of amorphous polyester fine particles, an aqueous dispersion of crystallizable polyester fine particles, an aqueous dispersion of amorphous vinyl resin fine particles, and if necessary, the C16-35 saturated compounds, a release agent, a colorant, and an aqueous dispersion of fine particles of a high molecular weight amorphous vinyl resin or the like. Then, these fine particles are aggregated to form wet toner base particles.

In the present invention, the wet toner base particles are dried under specific conditions to produce toner base particles.

Herein, the term “aqueous dispersion” refers to a material in which dispersions (particles) are dispersed in an aqueous medium. The aqueous medium refers to a medium in which the main component, that is, a component occupying 50% by mass or greater, is water.

Examples of the components other than water contained in the aqueous medium include organic solvents that dissolve in water. Examples of the water-soluble organic solvents include methanol, ethanol, isopropanol, butanol, acetone, methyl ethyl ketone, and tetrahydrofuran. Among these, from the viewpoint of not dissolving the resin, an alcohol-based organic solvent such as methanol, ethanol, isopropanol, and butanol are preferable.

Hereinafter, as an example of the method for producing a toner, a method for producing a toner containing the C16-35 saturated compound will be described. The present invention is not limited thereto, though.
(1) Synthesizing an amorphous polyester to prepare a dispersion of amorphous polyester fine particles
(2) Synthesizing a crystalline polyester to prepare a dispersion of crystalline polyester fine particles
(3) Synthesizing an amorphous vinyl resin having a weight average molecular weight of 10,000 to 40,000 to prepare a dispersion of amorphous vinyl resin fine particles
(4) Synthesizing an amorphous vinyl resin that is a high molecular weight body having a weight average molecular weight of 50,000 to 500,000 and preparing a dispersion of amorphous vinyl resin fine particles of the high molecular weight body
(5) Preparing a dispersion of colorant fine particles
(6) Aggregating amorphous polyester fine particles, crystalline polyester fine particles, amorphous vinyl resin fine particles having a weight-average molecular weight of 10,000 to 40,000, high molecular weight amorphous vinyl resin fine particles, the C16-35 saturated compound, a release agent, and colorant fine particles to form toner base particles
(7) Aging toner base particles with thermal energy to control the shape of the toner base particles
(8) Cooling the dispersion of toner base particles
(9) Separating the toner base particles from the aqueous medium by filtration, and washing the toner base particles to remove the surfactant and the like therefrom, thereby obtaining wet toner base particles
(10) Desolvating the wet toner base particles
(11) Drying the wet toner base particles with an airflow in a dryer
(12) Adding an external additive to the dried toner base particles

### (1) Synthesizing an Amorphous Polyester to Prepare a Dispersion of Amorphous Polyester Fine Particles

In this step, the amorphous polyester is synthesized by a conventionally known method, and the amorphous polyester is dispersed in the form of fine particles in an aqueous medium to prepare a dispersion of amorphous polyester fine particles.

Specifically, first, the amorphous polyester is dissolved or dispersed in an organic solvent to prepare an oil phase liquid. Next, the oil phase liquid is dispersed in an aqueous medium by phase inversion emulsification or the like to form oil droplets controlled to have a desired particle diameter. Thereafter, the organic solvent is removed to prepare an aqueous dispersion of amorphous polyester fine particles.

The amount of the aqueous medium used is preferably in a range of 50 to 2,000% by mass and more preferably in a range of 100 to 1,000% by mass with respect to the total mass of the oil phase liquid.

A surfactant or the like may be added to the aqueous medium from the viewpoint of the dispersion stability of the oil droplets. Examples of the surfactant include various conventionally known anionic surfactants, cationic surfactants, and nonionic surfactants.

From the viewpoint of removal treatment after formation of oil droplets, the organic solvent used in the preparation of the oil phase liquid preferably has a low boiling point and low solubility in water. Specific examples thereof include methyl acetate, ethyl acetate, methyl ethyl ketone, methyl isobutyl ketone, toluene, and xylene.

One of these may be used alone, or two or more of these may be used in combination.

The amount of the organic solvent used is preferably in the range of 1 to 300% by mass with respect to the total mass of the amorphous polyester.

The emulsification and dispersion of the oil phase liquid can be achieved using mechanical energy.

The amorphous polyester fine particles preferably have an average particle size in the range of 100 to 400 nm in terms of volume-based median size (d50). The volume-based median diameter (D50) can be measured using, for example, “Microtrac UPA-150” (manufactured by Nikkiso Co., Ltd).

### (2) Synthesizing a Crystalline Polyester to Prepare a Dispersion of Crystalline Polyester Fine Particles

The aqueous dispersion of crystalline polyester fine particles can also be prepared in the same manner as the aqueous dispersion of amorphous polyester fine particles. If necessary, the temperature at the time of dispersion is preferably adjusted.

### (3) Synthesizing an Amorphous Vinyl Resin Having a Weight Average Molecular Weight of 10,000 to 40,000 to Prepare a Dispersion of Amorphous Vinyl Resin Fine Particles

In this step, an amorphous vinyl resin having a weight-average molecular weight of 10,000 to 40,000 is synthesized by a known method, and the amorphous vinyl resin is dispersed in the form of fine particles in an aqueous medium to prepare a dispersion of amorphous vinyl resin fine particles.

(4) Synthesizing an Amorphous Vinyl Resin that is a High Molecular Weight Body Having a Weight Average Molecular Weight of 50,000 to 500,000 and Preparing a Dispersion of Amorphous Vinyl Resin Fine Particles of the High Molecular Weight Body

In this step, the amorphous vinyl resin that is a high molecular weight material is synthesized by a known method, and the amorphous vinyl resin is dispersed in the form of fine particles in an aqueous medium to prepare a dispersion of high molecular weight amorphous vinyl resin fine particles.

Internal additives such as a release agent and a charge control agent may be contained in the toner base particles as necessary. Such an internal additive may be introduced into the toner base particles by being dissolved or dispersed beforehand in, for example, a monomer solution for synthesizing the amorphous polyester, the crystalline polyester, or the amorphous vinyl resin.

In a case where the release agent is not dissolved or dispersed beforehand in the monomer solution for synthesizing the amorphous polyester, the crystalline polyester, or the amorphous vinyl resin, a dispersion liquid of release agent fine particles may be separately prepared, and the dispersion liquid of release agent fine particles may be added together with other resin particle dispersion liquid to aggregate the particles, as described later.

Further, the C16-35 saturated compound may be introduced into the toner base particles by dissolving or dispersing the C16-35 saturated compound in the monomer solutions for synthesizing the amorphous polyesters, the crystalline polyesters, or the amorphous vinyl resins beforehand, similarly to the release agent and so forth.

The aqueous dispersion of the release agent fine particles can be prepared by dispersing the release agent in an aqueous medium to which a surfactant is added at a critical micelle concentration (CMC) or greater.

The release agent can be dispersed by utilizing mechanical energy. The disperser is not particularly limited, and examples thereof include ultrasonic dispersers; mechanical homogenizers; pressurized dispersers such as Manton-Gaulin and pressure-type homogenizers; and medium-type dispersers such as a sand grinder and a diamond fine mill.

The volume-based median size (D50) of the release agent fine particles in a dispersed state is preferably in a range of 10 to 300 nm, more preferably in a range of 100 to 200 nm, and particularly preferably in a range of 100 to 150 nm. The volume-based median diameter (D50) of the release agent fine particles can be measured, for example, with an electrophoretic light scattering photometer “ELS-800” (manufactured by Otsuka Electronics Co., Ltd).

### (5) Preparing a Dispersion of Colorant Fine Particles

The aqueous dispersion of colorant fine particles can be prepared in the same manner as the aqueous dispersion of release agent fine particles. The release agent fine particles are preferably heated to a melting point or higher for dispersion, but the colorant fine particles are not necessarily heated.

(6) Aggregating Amorphous Polyester Fine Particles, Crystalline Polyester Fine Particles, Amorphous Vinyl Resin Fine Particles Having a Weight-Average Molecular Weight of 10,000 to 40,000, High Molecular Weight Amorphous Vinyl Resin Fine Particles, the C16-35 Saturated Compound, a Release Agent, and Colorant Fine Particles to Form Toner Base Particles

In this step, the C16-35 saturated compound, the release agent, and the aggregating agent in an amount equal to or greater than the critical aggregation concentration are added to the aqueous dispersion in which the above-described fine particles are dispersed; these fine particles are aggregated to some extent; and an additional dispersion of the binder polymer particles not containing the C16-36 saturated compound is further added. These fine particles are fusion-bonded to control their shape to produce the toner base particles.

The aggregating agent is not particularly limited, but is preferably, for example, a metal salt such as an alkali metal salt or an alkaline earth metal salt. Examples of the metal salts include salts of monovalent metals such as sodium, potassium, and lithium; salts of divalent metals such as calcium, magnesium, and manganese; and salts of trivalent metals such as iron, and aluminum.

Specific examples of the metal salt include sodium chloride, potassium chloride, lithium chloride, calcium chloride, magnesium chloride, zinc chloride, copper sulfate, magnesium sulfate, manganese sulfate, aluminum chloride, aluminum sulfate, polyaluminum chloride, and polyaluminum hydroxide. Among them, the metal salt is preferably a trivalent metal salt from the viewpoint of the ability to causing aggregation with a smaller amount.

One of these may be used alone, or two or more of these may be used in combination.

(7) Aging Toner Base Particles with Thermal Energy to Control the Shape of the Toner Base Particles

This step is performed as necessary when the toner base particles are aged by thermal energy to control their shapes.

Specifically, in the aging treatment, the dispersion liquid of the toner base particles is heated and stirred while adjusting the heating temperature, the stirring speed, the heating time, and the like, so that the circularity of the toner base particles becomes a desired value.

### (8) Cooling the Dispersion of Toner Base Particles

In this step, the dispersion liquid of the toner base particles is cooled. The cooling rate is preferably in a range of 1 to 20° C./min. The specific method of the cooling treatment is not particularly limited. The example methods include a cooling method by introducing a refrigerant from the outside of the reaction vessel, a cooling method by directly charging cold water into the reaction system, a cooling method by using a heat exchanger and the like.

(9) Separating the Toner Base Particles from the Aqueous Medium by Filtration, and Washing the Toner Base Particles to Remove the Surfactant and the Like Therefrom, Thereby Obtaining Wet Toner Base Particles

In this step, the toner base particles are subjected to solid-liquid separation from the cooled dispersion liquid of the toner base particles. Next, the obtained toner cake is washed to remove adhered substances such as the surfactant and the coagulant, thereby obtaining wet toner base particles. The “toner cake” as used herein refers to an aggregate of wet toner base particles aggregated in a cake form.

The method of solid-liquid separation is not particularly limited, and examples thereof include centrifugation; a vacuum filtration method using a Nutsche filter or the like; and a filtration method using a filter press or the like. In the washing, the filtrate is preferably washed with water until the electrical conductivity of the filtrate becomes less than 10 μS/cm.

### (10) Desolvating the Wet Toner Base Particles

This step is performed as necessary when the amount of the solvent contained in the wet toner base particles is reduced.

By performing the desolvation treatment, the amount of the solvent contained in the obtained wet toner base particles can be reduced. In addition, the amount of the solvent contained in the obtained wet toner base particles can be adjusted by adjusting the time, rotation conditions, pressurization conditions, and the like in the desolvation treatment.

### (11) Step of Drying Wet Toner Base Particles

In this step, the wet toner base particles subjected to the washing treatment and further subjected to the desolvation treatment in some cases are dried by a dryer.

Examples of the dryer include a spray dryer, a vacuum freeze dryer, and a reduced pressure dryer. In particular, it is preferable to use a stationary shelf dryer, a movable shelf dryer, a fluidized bed dryer, a rotary dryer, or a stirring dryer be used as the drier.

The water content of the dried toner base particles is preferably 5% by mass or less, and more preferably 2% by mass or less.

When the dried toner base particles are aggregated by a weak inter-particle attractive force, the aggregate may be subjected to crushing processing. Examples of the crushing processing apparatus include mechanical crushing apparatuses such as a jet mill, a Henschel mixer, a coffee mill, and a food processor.

The drying temperature is preferably in the range of 10 to 45° C., more preferably in the range of 20 to 40° C. If the drying temperature is higher than 45° C., the crystalline component in the toner is brought into a molten state, which makes it difficult control the structure of the toner.

### (12) Adding an External Additive to the Dried Toner Base Particles

This step is performed as necessary when an external additive is added to the toner base particles.

The toner base particles can be directly used as a toner as they are. From the viewpoint of fluidity, chargeability, cleanability, and the like, external additives such as so-called fluidizing agents and cleaning aids may be further added to the toner base particles.

Examples of a device for mixing an external additive include mechanical mixing devices such as a Henschel mixer and a coffee mill.

The above steps (1) to (12) are an example of the method of preparing toner base particles, and the present invention is not limited thereto.

The toner base particles according to the present invention may have a core-shell structure. The toner base particles having shell layers can achieve both low-temperature fixability and heat resistance. When the shell layers are formed, the shell layers are preferably formed after the core particles are formed in the step (6). The shell layers are preferably formed of an amorphous resin. A method for forming the shell layers is not particularly limited, and a conventionally known method can be used.

### 5. Developer

The toner can be used as a magnetic or non-magnetic mono-component developer. Further, the toner may be mixed with a carrier to form a two-component developer.

When the toner is used as a two-component developer, magnetic particles formed of a conventionally known material can be used as the carrier. Examples of the material of the magnetic particles include metals such as iron, ferrite, and magnetite; and alloys of these metals with metals such as aluminum and lead. Among them, the magnetic particles are preferably ferrite particles.

The carrier may be a coated carrier in which the surface of magnetic particles is coated with a coating agent such as a resin, a dispersion type carrier in which a magnetic fine powder is dispersed in a binding resin, or the like.

The volume-based median diameter (D50) of the carrier is preferably in a range of 20 to 100 μm, and more preferably in a range of 25 to 80 μm. The volume-based median diameter (D50) of the carrier can be measured, for example, with a laser diffraction particle size distribution analyzer “HELOS” (manufactured by SYMPATEC GmbH) equipped with a wet disperser.

A mixing device to be used for mixing the toner and the carrier is not particularly limited, and examples thereof include a Nauta mixer, a W-cone type mixer, and a V-type mixer.

The content of the toner in the developer is preferably in a range of 4.0 to 8.0% by mass with respect to the total mass of the developer.

### 6. Image Forming System and Image Forming Apparatus

As described above, the image forming system of the present invention uses the toner containing the toner base particles in which the content of the C16-35 saturated compound is 1,000 ppm by mass or less with respect to the total mass of the toner, and the system includes a means that fixes the toner to form an image. The means for forming the image is preferably an image forming apparatus of an electrophotographic method described below. Further, when an image having an adhesion amount of 4 g/m² or greater is formed on the resin recording medium, the peak density Spd of protrusions on the image surfaces is 5,000 mm⁻² or greater.

An image forming method using an electrophotographic method preferably includes a step of attaching the toner to the recording medium and a step of fixing the attached toner to the recording medium. Furthermore, to improve image quality and durability, the image forming method preferably includes a step of applying varnish to the surface of the toner image formed by the fixed toner to form a varnish coat.

The image forming method of the present invention is suitable for an image forming apparatus that forms images on continuous sheet media as a resin recording medium. The image forming method of the present invention is also applicable to an image forming apparatus that forms images on cut sheets.

Hereinafter, an example of the image forming apparatus using an electrophotographic method will be described. The present invention is not limited thereto, though.

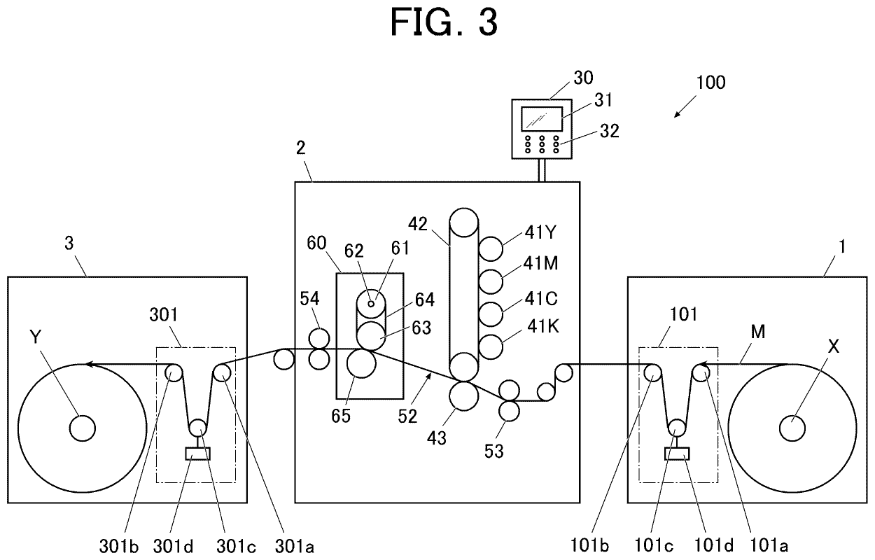

FIG. 3 is a diagram illustrating an example of an overall configuration of the image forming apparatus according to the present embodiment.

The image forming apparatus 100 illustrated in FIG. 3 is an apparatus that forms images on a continuous recording medium such as roll sheets or continuous forms.

The image forming apparatus 100 includes a sheet feed device (sheet feed section) 1, a main body 2, and a winding device (winding unit) 3 that are connected in this order from the upstream of the conveyance direction (sheet conveyance direction) of the continuous medium M. Although FIG. 3 shows a case where the sheet feed device 1 and the winding device 3 are configured separately from the main body 2, they may be configured integrally with the main body 2.

The sheet feed device 1 feeds the continuous medium M to the main body 2. The sheet feed device 1 conveys the continuous medium M that is wound around the support shaft X to the main body 2 at a constant speed by driving a not-illustrated motor. The motor of the sheet feed device 1 is controlled by a controller 10 included in the main body 2.

The sheet feed device 1 includes a tension applying mechanism 101 that applies tension to the continuous medium M.

The tension applying mechanism 101 includes driven rollers 101a and 101b, a dancer roller 101c, and a weight 101d. The fed continuous medium M is wound around the driven roller 101a, the dancer roller 101c, and the driven roller 101b and is inserted to the main body 2.

The main body 2 forms images on the continuous medium M fed by the sheet feed device 1 by an intermediate transfer method using an electrophotographic method.

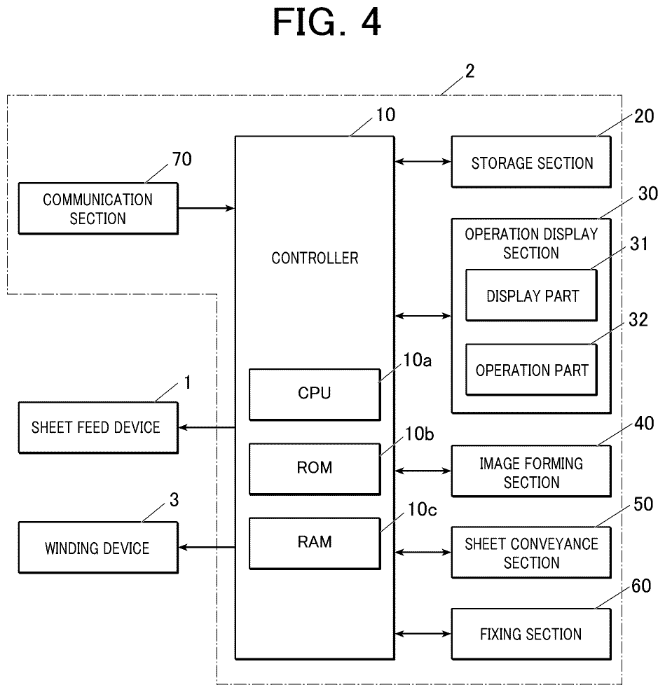

FIG. 4 illustrates main parts of the control system of the image forming apparatus 100. As illustrated in FIG. 4, the main body 2 includes a controller 10, a storage section 20, an operation display part 30, an image forming section 40, a sheet conveyance section 50, a fixing section 60, and a communication section 70.

The controller 10 includes a central processing unit (CPU) 10a, a read only memory (ROM) 10b, and a random access memory (RAM) 10c. The CPU 10a reads a program corresponding to the processing content from the ROM 10b, loads the program into the RAM 10c, and centrally controls the operations of the respective units of the main body 2, the sheet feed device 1, and the winding device 3 in accordance with the developed program.

The storage section 20 includes, for example, a nonvolatile semiconductor memory (so-called flash memory) and/or a hard disk drive. The storage section 20 stores input document data, various kinds of setting information, image data, and so forth. These data may be stored in the RAM 10c of the controller 10.

The operation display part 30 includes, for example, a liquid crystal display (LCD) with a touch screen, and functions as the display part 31 and the operation part 32.

The display part 31 displays various kinds of operation screens, the state of images, operating situations of the respective functions, and so forth in accordance with display control signals received from the controller 10.

The operation part 32 includes various kinds of operation keys such as numeric keypad and a start key. The operation part 32 receives various input operations by a user and outputs operation signals to the controller 10.

The image forming section 40 forms (prints) an image by: forming toner images of the respective colors of Y (yellow), M (magenta), C (cyan), and K (black) on photosensitive drums 41Y, 41M, 41C, and 41K, based on image data input from an external device (e.g., personal computer) via the communication section 70; sequentially transferring the toner images onto the intermediate transfer belt 42 to superimpose the four-color toner images (primary transfer); and transferring, using transfer rollers 43, the superimposed toner images to the continuous medium M fed by the sheet feed device 1 (secondary transfer), for example.

The sheet conveyance section 50 includes a sheet feed path 52 including a plurality of conveyance rollers.

Under the control of the controller 10, the sheet conveyance section 50 conveys, to the image forming section 40, the continuous medium M conveyed from the sheet feed device 1 to the main body 2, and conveys the continuous medium M on which a toner image has been formed by the image forming section 40 to the fixing section 60. The sheet conveyance section 50 then conveys the continuous medium M on which the toner image has been fixed by the fixing section 60 to the winding device 3.

At least a pair of nip rollers 53 is provided upstream of the fixing section 60 and downstream of the sheet feed device 1 in the sheet feed path 52. Further, at least a pair of nip rollers 54 is provided downstream of the fixing section 60 and upstream of the winding device 3. The nip rollers 53 and 54 can be pressed against and separated from each other by a pressing drive mechanism. The respective pairs of nip rollers 53 and 54 are pressed while tension is applied to the continuous medium M by a tension applying mechanism 101 and a tension applying mechanism 301. Thus, it is possible to maintain the tension applied to the continuous medium M between the nip rollers 53 and 54 even when the rollers stop rotating and the tension applying mechanisms 101 and 301 stop applying tension.

The fixing section 60 heats and presses the continuous medium M on which the toner image has been formed using the fixing nip, thereby fixing the toner image on the continuous medium M.

The fixing section 60 includes a heating roller 61, a heat source 62 that heats the heating roller 61, an upper pressure roller 63, an endless fixing belt 64 stretched around the heating roller 61 and the upper pressure roller 63, and a lower pressure roller 65. The heating roller 61 to the fixing belt 64 are provided at the fixing surface side of the continuous medium M. The lower pressure roller 65 is provided to face the fixing belt 64 with the sheet conveyance path 52 of the continuous medium M in-between (i.e., at the back surface side of the continuous medium M). There may be a heat source for heating the lower pressure roller 65.

The lower pressure roller 65 is movable, and the upper pressure roller 63 and the lower pressure roller 65 can be brought into pressure contact with each other and separated from each other by a not-illustrated pressure contact drive mechanism.

By pressing and separating the upper pressure roller 63 and the lower pressure roller 65, it is possible to press and separate the fixing belt 64 and the lower pressure roller 65. The fixing belt 64 and the lower pressure roller 65 being pressed against each other forms a fixing nip for holding and conveying the continuous medium M. The continuous medium M is heated and pressurized when passing through the fixing nip between the fixing belt 64 heated by the heat source 62 and the lower pressure roller 65. Thus, the toner image is fixed.

The communication section 70 includes, for example, a communication control card such as a local area network (LAN) card. The communication section 70 sends and receives various kinds of data to and from an external device (e.g., a personal computer) connected to a communication network such as a LAN or a wide area network (WAN).

The winding device 3 winds the continuous medium M conveyed from the main body 2. Driven by a not-illustrated motor, the winding device 3 winds the continuous medium M conveyed from the main body 2 around the support shaft Y at a constant speed. The winding operation of the winding device 3 is controlled by the controller 10 of the main body 2.

Furthermore, the winding device 3 includes the tension applying mechanism 301 that applies tension to the continuous medium M. The tension applying mechanism 301 includes driven rollers 301a and 301b, a dancer roller 301c, and a weight 301d. The continuous medium M conveyed from the main body 2 receives tension by being wound around the driven roller 301a, the dancer roller 301c, and the driven roller 301b, and is conveyed to the support shaft Y.

In the present embodiment, the sheet feed device 1 and the winding device 3 each include a tension applying mechanism. However, only either of them may include a tension applying mechanism.

The above-described device configuration and image forming method are an example for carrying out the present invention, and the present invention is not limited thereto.

### [Formation of Varnish Coat]

It is preferable to apply varnish to the image formed by the above-described image forming method to form a varnish coat.

The varnish coat is formed by applying a photocurable varnish containing a photopolymerizable compound to the image formed by the above-described image forming process and curing the varnish to form a varnish layer, for example. The photocurable varnish may be applied to cover the entire image or may be applied to cover only a part of the image.

The method for applying the photocurable varnish to the image is not limited to a specific method as long as the photocurable varnish is uniformly applied.

Examples of a coating device include liquid film coating devices, such as a varnish coater, a roll coater, a flexible coater, a rod coater, a blade, a wire bar, an air knife, a curtain coater, a slide coater, a doctor knife, a screen coater, a gravure coater (e.g., an offset gravure coater), a slot coater, and an extrusion coater. Further, coating may be done by well-known methods, such as forward and reverse roll coating, offset gravure, curtain coating, lithographic coating, screen coating, and gravure coating.

The photocurable varnish to be applied to the image may contain a photopolymerizable compound (polymerizable monomer for varnish). Usually, the photocurable varnish contains a polymerization initiator (sensitizer) along with the photopolymerizable compound.

The photopolymerizable compound may be a monomer, an oligomer, or a polymer. The photopolymerizable compound includes at least diol di (meth) acrylate having a linear hydrocarbon structure.

When the photocurable varnish contains the diol di (meth) acrylate, the varnish has an increased affinity with the crystalline polyester in the toner particles. Accordingly, the wettability of the photocurable varnish to an image is improved, and the adhesion between the varnish layer and the image is increased.

Here, the diol di (meth) acrylate having a linear hydrocarbon structure is a monomer obtained by dehydration assembly of an aliphatic diol and two (meth) acrylic acids. The hydrocarbon structure of the diol di (meth) acrylate may be partially branched. In this case, a hydrocarbon chain sandwiched between two oxygen atoms derived from the diol is specified as a linear hydrocarbon structure.

The number of carbon atoms of the linear hydrocarbon structure of the diol di (meth) acrylate is preferably 4 to 12, more preferably 6 to 10, and further preferably 6 to 9. When the number of carbon atoms of the linear hydrocarbon structure of the diol di (meth) acrylate is within the above range, the photocurable varnish has an appropriate level of viscosity, and a satisfactory level of coatability is achieved. Further, the varnish can have a satisfactory affinity with the crystalline polyester in the toner particles.

Specific examples of the diol di (meth) acrylate include hexanediol diacrylate, nonanediol diacrylate, and decanediol diacrylate. Among these, hexanediol diacrylate is preferable.

The amount of the diol di (meth) acrylate having a linear hydrocarbon structure is preferably 10 to 80% by mass, and more preferably 20 to 65% by mass, with respect to the total mass of the photopolymerizable compounds. When the amount of the diol di (meth) acrylate is within the above range, the adhesion between an image and the varnish layer becomes satisfactory.

Examples of the photopolymerizable compound other than diol di (meth) acrylate include an acrylic resin; a polymerizable oligomer or a polymerizable polymer, such as a vinyl-acrylic-based resin, an acrylic acid ester of a polyhydric alcohol, epoxy acrylate, urethane acrylate, polyester acrylate, polyether acrylate, acrylate alkyd, and melamine acrylate; a (meth) acrylate monomer, such as trimethylolpropane (meth) acrylate and phenoxyethyl (meth) acrylate; and a tri (meth) acrylate monomer. The amount and type of the photopolymerizable compound other than the diol di (meth) acrylate are appropriately determined according to the curability, viscosity, and surface tension of the photocurable varnish.

Examples of the polymerization initiator (sensitizer) include known anthraquinone-based initiators, benzophenone-based initiators, 2-ethylanthraquinone-based initiators, acylphosphine oxide-based initiators, and alkylphenone-based photopolymerization initiators.

The amount of the polymerization initiator is preferably 5 to 25% by mass with respect to the total mass of the photocurable varnish. When the amount of the polymerization initiator is within the above range, the curability of the photocurable varnish becomes satisfactory.

Furthermore, the photocurable varnish may contain a surfactant.

Examples of the surfactant include an anionic surfactant, a nonionic surfactant, a silicone surfactant, and a fluorosurfactant.

Examples of the anionic surfactant include sulfosuccinates, disulfonates, phosphate esters, sulfates, and sulfonates.

Examples of nonionic surfactants include polyvinyl alcohol, polyacrylic acid, isopropyl alcohol, acetylenic diols, ethoxylated octylphenol, ethoxylated branched secondary alcohols, perfluorobutane sulfonate, and alkoxylated alcohols.

Examples of the silicone surfactant include polyether-modified polydimethylsiloxane.

Examples of fluorosurfactants include ethoxylated nonylphenol.

When the photocurable varnish contains a surfactant, the adhesion between the image and the varnish layer may be improved. Further, the surfactant contributes to adjusting the surface tension of the photocurable varnish to enhance the wettability of the photocurable varnish.

The surface tension of the photocurable varnish at 25° C. is preferably 10 to 50 mN/m, more preferably 15 to 45 mN/m, and further preferably 20 to 40 mN/m. When the surface tension of the photocurable varnish is within the above range, the photocurable varnish easily spreads on an image.

The surface tension of the photocurable varnish is measured by a plate method with KYOWA DY300 (manufactured by Kyowa Interface Science Co., Ltd).

On the other hand, the viscosity of the photocurable varnish at 25° C. measured 30 seconds after immersing a vibrator in the liquid is preferably 100 to 800 mPa·s. The viscosity is more preferably 150 to 700 mPa·s, and further preferably 200 to 600 mPa·s. When the viscosity of the photocurable varnish is within the above range, the varnish can be easily applied to images by the above-described method.

After the photocurable varnish is applied, the photocurable varnish is cured by irradiation with light energy.

The type of light energy for irradiation is appropriately selected, based on the type of the polymerization initiator. Usually, ultraviolet light or visible light can be used, for example.

Examples of the light source of light energy include a low-pressure mercury lamp, a medium-pressure mercury lamp, a high-pressure mercury lamp, an ultrahigh-pressure mercury lamp, a xenon lamp, a carbon arc lamp, a metal halide lamp, a fluorescent lamp, a tungsten lamp, and an LED. The amount of light and the irradiation time are appropriately determined.

Other than the above-described photo-curable varnish, the varnish coat may be formed by applying a solvent-based varnish and drying the solvent.

### EXAMPLES

Hereinafter, the present invention will be specifically described with reference to Examples, but the present invention is not limited thereto. Note that the operations in the following Examples were performed at room temperature (25° C.) unless otherwise specified. Further, unless otherwise specified, “%” and “part(s)” mean “% by mass” and “part(s) by mass”, respectively.

### <Saturated Hydrocarbon Compound [H]>

Saturated hydrocarbons having 20 carbon atoms, 26 carbon atoms, 30 carbon atoms, and 34 carbon atoms (manufactured by GL Science Co., Ltd) were fractionated at a mass ratio of 20:30:30:20. The saturated hydrocarbons were mixed and melted at 80° C., and then cooled and solidified to obtain a saturated hydrocarbon compound [H] having 16 to 35 carbon atoms.

### <Preparation of Dispersion of Amorphous Vinyl Resin Particles [B1]>

Styrene: 432.0 parts by mass
N-Butyl acrylate: 225.0 parts by mass
Methacrylic acid: 61.2 parts by mass

In a reaction vessel having a capacity of 5 liter and equipped with a stirrer, a temperature sensor, a cooling tube, and a nitrogen introduction device, 8 parts by mass of sodium dodecyl sulfate and 3000 parts by mass of ion exchanged water were prepared. Under a nitrogen gas stream, the liquid temperature was increased to 80° C. while being stirred at a stirring speed of 230 rpm. After the temperature was increased, a solution prepared by dissolving 10 parts by mass of potassium persulfate in 200 parts by mass of ion exchanged water was added; the liquid temperature was again heated to 80° C.; and the mixed liquid of the above monomers was added dropwise over 1 hour. After the dropwise addition, the liquid temperature was kept at 80° C., and the liquid was stirred for 2 hours to cause polymerization. Thus, a vinyl resin particle dispersion [b1] was prepared.
Styrene: 256.5 parts by mass
2-ethylhexyl acrylate: 85.5 parts by mass
Methacrylic acid: 18.0 parts by mass
N-octyl-3-mercaptopropionate (chain transfer agent): 5.40 parts by mass
Release agent [W1](microcrystalline wax): 135.0 parts by mass
Saturated hydrocarbon compounds having 16 to 35 carbon atoms [H]: 3.00 parts by mass

In a 5-liter reaction vessel equipped with a stirrer, a temperature sensor, a cooling tube, and a nitrogen introduction device, 7 parts by mass of sodium polyoxyethylene (2) dodecyl ether sulfate and 3000 parts by mass of ion-exchanged water were put. The mixture was heated to 80° C. After the heating, 80 parts by mass of the vinyl resin-particle dispersion liquid [b1] in terms of solid contents and a mixed liquid in which the monomers, the chain transfer agent, the release agent [W1], and the saturated hydrocarbon compounds [H] were dissolved at 90° C. were added.

Thereafter, a mixing and dispersing process was performed for 1 hour using a mechanical disperser having a circulation path (CLEARMIX, manufactured by M Technique Co., Ltd) to prepare a dispersion containing emulsified particles (oil droplets).

Next, an aqueous initiator solution prepared by dissolving 6 parts by mass of potassium persulfate in 200 parts by mass of ion-exchanged water was added to the dispersion, and the system was heated and stirred at 84° C. for 1 hour. Thus, the monomers were polymerized to prepare a dispersion of vinyl resin particles [b2].

To the vinyl resin particle dispersion [b2], 400 parts by mass of ion-exchanged H2O was further added. Thereafter, a solution prepared by dissolving 11 parts by mass of potassium persulfate in 400 parts by mass of ion-exchanged water was added. Under a temperature condition of 82° C., a mixed liquid of the following monomers was added dropwise over 1 hour.
Styrene: 330.3 parts by mass
N-Butyl acrylate: 148.5 parts by mass
Methacrylic acid: 49.5 parts by mass
N-octyl-3-mercaptopropionate: 7.2 parts by mass

After the dropwise addition, the mixture was heated and stirred for 2 hours to polymerize the monomers, and then cooled to 28° C. to obtain a dispersion of amorphous vinyl resin particles [B1].

The solid content of the dispersion of amorphous vinyl resin particles [B1] was 30% by mass, and the weight-average molecular weight (Mw) of the amorphous vinyl resin particle was 30,500.

### <Preparation of Dispersions of Amorphous Vinyl Resin Particles [B2] to [B10]>

Dispersions of amorphous vinyl resin particles [B2] to [B10] were obtained, wherein the type of the release agent and the amount of the saturated hydrocarbon compounds [H] were changed as shown in the following Table I. The weight-average molecular weight of the amorphous vinyl resin particles dispersed in these dispersions of amorphous vinyl resin particles [B1] to [B10] are within a range of 10,000 to 40,000.

In Table I below, the “parts by mass” of the saturated hydrocarbon compound represents the amount added at the time of preparation of the amorphous vinyl resin particle dispersion. Further, in Tables VI to VIII below, the term “ppm by mass” of the saturated hydrocarbon compound represents the content thereof with respect to the total mass of the toner. The “total mass of the toner” refers to the mass including the toner base particles and the external additive.

TABLE I

| | | | Saturated | |
|---|---|---|---|---|
| | | | hydrocarbon | |
| | | | compound | |
| | | | [Parts by mass] | Weight-average |
| | | | Amount added in | molecular |
| Amorphous vinyl | | | preparation of | weight of |
| resin particle | | | amorphous vinyl | amorphous vinyl |
| dispersion | Release agent | | resin dispersion | resin particles |
| No. | No. | Type | [Parts by mass] | (Mw) |
| [B1] | [W1] | Microcrystalline wax | 3 | 30500 |
| [B2] | [W2] | Behenyl behenate | 3 | 29700 |
| [B3] | [W1] | Microcrystalline wax | 0.006 | 31800 |
| [B4] | [W1] | Microcrystalline wax | 5.85 | 37500 |
| [B5] | [W1] | Microcrystalline wax | 0.03 | 31900 |
| [B6] | [W1] | Microcrystalline wax | 5 | 26400 |
| [B7] | [W1] | Microcrystalline wax | 0.003 | 25800 |
| [B8] | [W1] | Microcrystalline wax | 0 | 29900 |
| [B9] | [W2] | Behenyl behenate | 0 | 28000 |
| [B10] | [W1] | Microcrystalline wax | 10 | 38000 |

### <Preparation of Dispersion of Amorphous Vinyl Resin Particles [Si](Preparation of High Molecular Weight Body)>

A reaction vessel 5 L equipped with a stirrer, a temperature sensor, a cooling tube, and a nitrogen introduction device was prepared. In the reaction vessel, a mixed solution prepared by dissolving 1,100 parts by mass of ion-exchanged water, the following monomers, a chain transfer agent, and a release agent at 85° C. was subjected to a mixing and dispersing process for 10 minutes by using a mechanical dispersing machine CLEARMIX having a circulation path (manufactured by M Technique Co., Ltd). Thus, a dispersion containing emulsified particles (oil droplets) was prepared. The dispersion was added to the above 5-liter reaction vessel, and a polymerization initiator prepared by dissolving 5.4 parts by mass of potassium persulfate in 103 parts by mass of deionized water was added. The system was heated and stirred at 87° C. for 1 hour for polymerization to prepare a dispersion of amorphous vinyl resin particles [S1].

The solid content of the obtained amorphous vinyl resin particle dispersion [S1] was 30% by mass, and the weight-average molecular weight (Mw) thereof was 310,000.
Styrene (St): 256.5 parts by mass
2-ethylhexyl acrylate (2-EHA): 95.3 parts by mass
Methacrylic acid (MAA): 38.2 parts by mass
N-octyl-3-mercaptopropionate (NOM, chain transfer agent): 2.0 parts by mass

### <Preparation of Dispersions of Amorphous Vinyl Resin Particles [S2] to [S4] (Preparation of High Molecular Weight Body)>

Dispersions of amorphous vinyl resin particles [S2] to [S4] were synthesized in the same manner as in the preparation of the dispersion of amorphous vinyl resin particles [S1] except that the components were changed as shown in the following table.

TABLE II

| Amorphous | | | | | |
|---|---|---|---|---|---|
| vinyl resin | St | 2-EHA | MAA | NOM | |
| particle | [Parts | [Parts | [Parts | [Parts | |
| dispersion No. | by mass] | by mass] | by mass] | by mass] | Mw |
| [S1] | 256.5 | 95.3 | 38.2 | 2.0 | 310000 |
| [S2] | 256.5 | 95.3 | 38.2 | 4.5 | 130000 |
| [S3] | 256.5 | 95.3 | 38.2 | 0.6 | 80000 |
| [S4] | 256.5 | 95.3 | 38.2 | 3.5 | 550000 |

<Preparation of Amorphous Polyester [a2]

The following amorphous polyester monomers other than trimellitic acid were put in a four-necked flask equipped with a nitrogen inlet tube, a dewatering tube, a stirrer, and a thermocouple, and the temperature was raised to 235° C.

### (Polyhydric Alcohol)

Pentanediol: 66.0 parts by mass
Ethylene glycol: 35.0 parts by mass

### (Polyvalent Carboxylic Acid)

Terephthalic acid: 100.0 parts by mass
Dodecenyl succinic acid: 130.0 parts by mass
Trimellitic acid: 15.0 parts by mass

Then, the atmosphere in the reaction vessel was replaced with dry nitrogen gas, and 0.3% by mass of tin dioctanoate with respect to the total mass of the above monomer components was put into the reaction vessel. Under a nitrogen stream, the monomers were polycondensed for 5 hours and then reacted for 1 hour under reduced pressure of 8 kPa.
Styrene (St): 73.0 parts by mass
N-Butyl acrylate (BA): 15.0 parts by mass
Acrylic acid (AA): 7.3 parts by mass
Di-t-butyl peroxide (polymerization initiator): 7.5 parts by mass

The inside of the reaction vessel was cooled to 170° C., and the mixed liquid of the vinyl resin monomer, the bireactive monomer, and the polymerization initiator was put in a dropping funnel and added dropwise over 1 hour. The mixture was held at 170° C. for 1 hour for addition polymerization. Thereafter, the temperature was raised to 200° C., and the mixture was reacted for 1 hour under reduced pressure of 8 kPa. Thereafter, trimellitic acid was added, and the mixture was reacted at 210° C. for 1 hour. The volume-based median diameter (D50) of the obtained amorphous polyester [a2] was 150 nm, and the weight-average molecular weight thereof was 30,500.

### <Preparation of Dispersion of Amorphous Polyester Resin Particles [A2]>

The following components were put into a reaction vessel equipped with a stirrer and dissolved at 75° C.
Amorphous polyester [a2]: 100.0 parts by mass
Methyl ethyl ketone: 60.0 parts by mass
Isopropyl alcohol: 15.0 parts by mass

Next, the reaction vessel was cooled to 70° C., and the following components were added.
10% aqueous ammonia solution: 3.5 parts by mass
Ion exchange water: 300.0 parts by mass

Then, the above components were added dropwise to the reaction vessel over 3 hours. Next, methylethyl ketone and isopropyl alcohol were removed using an evaporator to obtain a dispersion of amorphous polyester resin particles [A2]. The solid content of the obtained amorphous polyester resin particle dispersion [A2] was 25% by mass. The volume-based median diameter (D50) of the amorphous polyester [a2] in the amorphous polyester resin particle dispersion [A2] was 140 nm.

### <Preparation of Dispersion of Amorphous Polyester Resin Particles (A1, A3 to A7)>

Amorphous polyesters [a1] and [a3] to [a7] were obtained in the same manner as in the synthesis example of amorphous polyester [a2], except that the type and parts by mass of the alcohol monomer and the parts by mass of the vinyl monomer were changed as shown in the table below. Next, amorphous polyester resin particle dispersions [A1] and [A3] to [A7] were obtained in the same procedure as in the synthesis example of the amorphous polyester resin particle dispersion [A2], except that the amorphous polyester [a2] was changed to [a1], [a3] to [a7], respectively.

TABLE III

| Amorphous | | | | | | Vinyl resin segment | | | | | | | |
|---|---|---|---|---|---|---|---|---|---|---|---|---|---|
| polyester resin | | Amorphous polyester | | | | Vinyl | | Vinyl | Bireactive | | | Polymerization | |
| particle | | Alcohol monomer | | Alcohol | | monomer | | monomer | monomer | | | initiator | |
| dispersion No. | *0 | 1 | *1 | monomer 2 | *1 | 1 | *1 | 2 | *1 | Kind | *1 | Kind | *1 |
| [A1] | [a1] | 1,6-hexanediol | 66 | Ethylene | 35 | Styrene | 40 | *2 | 8 | *3 | 4 | *4 | 7.5 |
| | | | | glycol | | | | | | | | | |
| [A2] | [a2] | Pentanediol | 66 | Ethylene | 35 | Styrene | 73 | *2 | 15 | *3 | 7.3 | *4 | 7.5 |
| | | | | glycol | | | | | | | | | |
| [A3] | [a3] | 1,3-Cyclopentanediol | 57 | Ethylene | 35 | Styrene | 39 | *2 | 8 | *3 | 4 | *4 | 7.5 |
| | | | | glycol | | | | | | | | | |
| [A4] | [a4] | Propylene glycol | 48 | Ethylene | 39 | Styrene | 38 | *2 | 7.4 | *3 | 3.6 | *4 | 7.5 |
| | | | | glycol | | | | | | | | | |
| [A5] | [a5] | Bisphenol A | 30 | Ethylene | 57 | Styrene | 73 | *2 | 15 | *3 | 7.3 | *4 | 7.5 |
| | | ethylene oxide | | glycol | | | | | | | | | |
| | | 2-mol adduct | | | | | | | | | | | |
| [A6] | [a6] | Bisphenol A | 280 | Bisphenol A | 114 | Styrene | 73 | *2 | 15 | *3 | 7.3 | *4 | 7.5 |
| | | ethylene oxide | | ethylene oxide | | | | | | | | | |
| | | 2-mol adduct | | 2-mol adduct | | | | | | | | | |
| [A7] | [a7] | 1, 6-hexanediol | 66 | Ethylene | 35 | Styrene | 0 | *2 | 0 | *3 | 0 | *4 | 0 |
| | | | | glycol | | | | | | | | | |

*0: Amorphous polyester No.
*1: Parts by mass
*2: N-butyl acrylate
*3: Acrylic acid
*4: Di-t-butyl peroxide

<Preparation of Crystalline Polyester [c1]> (Hybrid of Styrene-Acrylic Resin and Crystalline Polyester)

The following monomers of crystalline polyester were placed in a four-necked flask equipped with a nitrogen inlet tube, a dehydration tube, a stirrer, and a thermocouple, and the temperature was raised to 235° C.

### (Polyvalent Carboxylic Acid)

Tetradodecanedioic acid: 400 parts by mass

### (Polyhydric Alcohol)

1,4-Butanediol: 130 parts by mass

Next, the atmosphere in the reaction vessel was replaced with dry nitrogen gas, and 0.3% by mass of tin dioctanoate with respect to the total mass of the above monomer components was put into the reaction vessel. Under a nitrogen stream, the monomers were polycondensed for 5 hours and then reacted for 1 hour under reduced pressure of 8 kPa.
Styrene (St): 40 parts by mass
N-butyl acrylate (BA): 16 parts by mass
Acrylic acid (AA): 3.5 parts by mass
Polymerization initiator (di-t-butyl peroxide): 8 parts by mass

The inside of the reaction vessel was cooled to 170° C., and the mixed liquid of the vinyl resin monomer, the bireactive monomer, and the polymerization initiator was put in a dropping funnel and added dropwise over 1 hour. The inside of the reaction vessel was then held at 170° C. for 1 hour for addition polymerization. Thereafter, the temperature was raised to 200° C., and the mixture was reacted under reduced pressure of 8 kPa for 1 hour. The weight-average molecular weight of the obtained crystal polyester [c1] was 8,500.

<Preparation of Crystalline Polyester [c2]>

The following monomers of crystalline polyester were placed in a four-necked flask equipped with a nitrogen inlet tube, a dehydration tube, a stirrer, and a thermocouple, and the temperature was raised to 235° C.

### (Polyvalent Carboxylic Acid)

Tetradodecanedioic acid: 390.0 parts by mass

### (Polyhydric Alcohol)

1,4-Butanediol: 140.0 parts by mass

Next, the atmosphere in the reaction vessel was replaced with dry nitrogen gas, and 0.3% by mass of tin dioctanoate with respect to the total mass of the above monomer components was put into the reaction vessel. Under a nitrogen stream, the monomers were polycondensed for 5 hours and then reacted for 1 hour under reduced pressure of 8 kPa. The weight-average molecular weight of the obtained crystal polyester [c2] was 9,500.

TABLE IV

| Crystalline | | | | | | | | | | | | | |
|---|---|---|---|---|---|---|---|---|---|---|---|---|---|
| polyester | | | | | | Vinyl resin segment | | | | | | | |
| resin | | Crystalline polyester resin | | | | Vinyl | | Vinyl | | | | Polymerization | |
| particles | | | | Alcohol | | monomer | | monomer | | Bireactive | | initiator | |
| No. | *0 | Acid monomer | *1 | monomer | *1 | 1 | *1 | 2 | *1 | monomer | *1 | Kind | *1 |
| [C1] | [c1] | Tetradodecanedioic | 400 | 1,4-Butanediol | 130 | Styrene | 40 | *2 | 16 | *3 | 3.5 | *4 | 8 |
| | | acid | | | | | | | | | | | |
| [C2] | [c2] | Tetradodecanedioic | 390 | 1,4-Butanediol | 140 | Styrene | 0 | *2 | 0 | *3 | 0 | *4 | 0 |
| | | acid | | | | | | | | | | | |

*0: Crystalline polyester No.
*1: Parts by mass
*2: N-butyl acrylate
*3: Acrylic acid
*4: Di-t-butyl peroxide

### <Preparation of Cyan Colorant Particle Dispersion [P1]>

Cyan pigments (manufactured by Dainichiseika Color & Chemicals Mfg. Co., Ltd., Pigment Blue 15:3 (copper phthalocyanine)): 45.0 parts by mass
Anionic surfactant “NEOGEN (R) R” (manufactured by Dai-ichi Kogyo Seiyaku Co., Ltd): 2.0 parts by mass
Ion exchange water: 250.0 parts by mass

The above components were mixed and dispersed using a high-pressure impact disperser Ultimizer “HJP30006” (manufactured by Sugino Machine Co., Ltd.) to obtain a cyan colorant dispersion [P1]. The volume-based median diameter (D50) of the obtained colorant particles was 150 nm.

### <Preparation of Toner Base Particles [1]>

### <Aggregation and Fusion Process>

The following materials were placed in a 4-liter reaction vessel equipped with a thermometer, a pH meter, and a stirrer, and 1.0% nitric acid was added thereto at a temperature of 25° C. to adjust the pH to 3.0. Thereafter, 100 parts by mass of an aluminum sulfate aqueous solution (aggregating agent) having a concentration of 2% was added over 30 minutes while dispersing at 3000 rpm using a homogenizer (ULTRA-TURRAX T50, manufactured by Ika-Werke GmbH & Co. KG). After completion of the dropwise addition, the mixture was stirred for 10 minutes to sufficiently mix the raw materials and the aggregating agent.
Amorphous vinyl resin particle dispersion [B1]: 932 parts by mass
Dispersion of amorphous vinyl resin particles [Si]: 14 parts by mass
Dispersion of Amorphous Polyester Resin Particles [A1]: 61 parts by mass
Dispersion of crystalline polyester resin particles [C1]: 135.2 parts by mass
Dispersion of cyan colorant particles [P1]: 155.0 parts by mass
Anionic surfactant (Dowfax2A1 20% aqueous solution): 40 parts by mass
Ion-exchange water: 1,200 parts by mass

Thereafter, a stirrer and a mantle heater were provided to the reaction vessel, and while the number of rotations of the stirrer was adjusted so that the slurry was sufficiently stirred, the temperature was increased at a temperature increase rate of 0.2° C./min until the temperature reached 40° C. and at a temperature increase rate of 0.05° C./min after the temperature exceeded 40° C. The particle size was measured every 10 minutes using a Coulter Multisizer 3. The Coulter Multisizer 3 has an aperture diameter of 100 μm and is manufactured by Beckman Coulter, Inc.

When the volume average particle diameter reached 5.8 μm, the temperature was maintained, and the following mixed liquid mixed beforehand was added thereto over 20 minutes.
Amorphous polyester resin particle dispersion (A1): 209 parts by mass
Anionic surfactant (Dowfax2A1 20% aqueous solution): 15 parts by mass

Next, after the resulting product was held at 50° C. for 30 minutes, 8 parts by mass of a 20% solution of ethylenediaminetetraacetic acid (EDTA) was added to the reaction vessel, and then an aqueous sodium hydroxide solution of 1 mol/L was added to control the pH of the row material dispersion to 9.0. Thereafter, the temperature was increased to 85° C. at a temperature increase rate of 1° C./min while the pH was adjusted to 9.0 with each 5° C. increase, and then the temperature was maintained at 85° C.

### <Cooling Step>

Thereafter, when the shape factor reached 0.965 with “FPIA-3000”, the mixture was cooled at a temperature decrease rate of 10° C./min to obtain a toner base particle dispersion [1]. The volume-based median diameter (D50) of particles in the toner base particle dispersion [1] was 6.2 μm, and the average circularity thereof was 0.966.

### <Filtering-Washing Step and Drying Step>

Thereafter, the toner base particle dispersion [1] was filtered and sufficiently washed with ion-exchanged water. Next, the resultant was dried at 40° C. to obtain toner base particles [1].

### <Preparation of Toner Base Particles [2] to [25]>

Toner base particles [2] to [25] were prepared in the same manner as in the preparation of toner base particles [1], except that the amounts (% by mass) of the respective resin particle dispersions were changed as shown in Table V below.

In Table V below, the amount (% by mass) of each resin particle dispersion represents the amount (% by mass) of each resin particle dispersion with respect to the total mass of the binding resin (the total mass of the amorphous vinyl resin particle dispersion, the amorphous polyester resin particle dispersion, and the crystalline polyester resin particle dispersion).

### <Preparation of Toner [1]>

The toner [1] was obtained by mixing the following toner base particles and fine particles with a Henschel mixer (FM-75, manufactured by Mitsuimiikekakouki, Inc.) at a rotational speed of 30 s⁻¹ for a rotational time of 10 minutes.
Toner base particles [1]: 100 parts by mass
Hydrophobic silica fine particles hydrophobized with hexamethyldisilazane (BET specific surface area: 200 m²/g): 1.0 parts by mass
Titanium dioxide fine particles surface-treated with isobutyltrimethoxysilane (BET specific surface area: 80 m²/g): 1.0 parts by mass

### <Preparation of Toners [2] to [25]>

Toners [2] to [25] were obtained in the same manner as in the preparation of toner [1], except that the toner base particles used were changed to toner base particles [2] to [25], respectively.

### <Preparation of Developer>

First, 100 parts by mass of ferrite particles (volume-based median particle dimeter: 50 μm, manufactured by Powdertech Co., Ltd.) and 4 parts by mass of methyl methacrylate-cyclohexyl methacrylate (volume-based median particle diameter of primary particles: 85 nm) were put in a horizontal stirring blade type high-speed stirring apparatus and mixed for 15 minutes at 30° C. at a stirring blade peripheral speed of 8 m/s. Next, the temperature was increased to 120° C. and stirring was continued for 4 hours. Thereafter, the mixture was cooled, and broken pieces of the methyl methacrylate-cyclohexyl methacrylate copolymer resin were removed with a 200 mesh sieve to prepare a resin-coated carrier.

The resin-coated carrier was mixed with each of the above toners such that the concentration of the toner was 7% by mass with respect to the total mass of the toner and the carrier. Thus, two-component developers [2] to [25] were prepared.

TABLE V

| | | | | | | | Amorphous | | | |
|---|---|---|---|---|---|---|---|---|---|---|
| | | | Amorphous vinyl | | Amorphous vinyl | | polyester resin | | Crystalline | |
| | | Toner base | resin particle | | resin particle | | particle | | polyester resin | |
| Developer | Toner | particles | dispersion | | dispersion | | dispersion | | particle dispersion | |
| No. | No. | No. | No. | [% by mass] | No. | [% by mass] | No. | [% by mass] | No. | [% by mass] |
| [1] | [1] | [1] | [B1] | 69 | [S1] | 1 | [A1] | 20 | [C1] | 10 |
| [2] | [2] | [2] | [B2] | 69 | [S1] | 1 | [A2] | 20 | [C1] | 10 |
| [3] | [3] | [3] | [B1] | 69 | [S1] | 1 | [A3] | 20 | [C1] | 10 |
| [4] | [4] | [4] | [B1] | 69 | [S1] | 1 | [A4] | 20 | [C1] | 10 |
| [5] | [5] | [5] | [B3] | 69 | [S1] | 1 | [A1] | 20 | [C1] | 10 |
| [6] | [6] | [6] | [B4] | 69 | [S1] | 1 | [A1] | 20 | [C1] | 10 |
| [7] | [7] | [7] | [B5] | 69 | [S1] | 1 | [A1] | 20 | [C1] | 10 |
| [8] | [8] | [8] | [B6] | 69 | [S1] | 1 | [A1] | 20 | [C1] | 10 |
| [9] | [9] | [9] | [B1] | 86 | [S1] | 1 | [A1] | 3 | [C1] | 10 |
| [10] | [10] | [10] | [B1] | 84 | [S1] | 1 | [A1] | 5 | [C1] | 10 |
| [11] | [11] | [11] | [B1] | 9 | [S1] | 1 | [A1] | 80 | [C1] | 10 |
| [12] | [12] | [12] | [B1] | 40 | [S1] | 1 | [A1] | 50 | [C1] | 10 |
| [13] | [13] | [13] | [B1] | 4 | [S1] | 1 | [A1] | 85 | [C1] | 10 |
| [14] | [14] | [14] | [B1] | 69 | [S1] | 1 | [A5] | 20 | [C1] | 10 |
| [15] | [15] | [15] | [B1] | 70 | — | 0 | [A6] | 20 | [C1] | 10 |
| [16] | [16] | [16] | [B1] | 69 | [S1] | 1 | [A1] | 20 | [C2] | 10 |
| [17] | [17] | [17] | [B1] | 69 | [S1] | 1 | [A7] | 20 | [C2] | 10 |
| [18] | [18] | [18] | [B1] | 69 | [S2] | 1 | [A1] | 20 | [C1] | 10 |
| [19] | [19] | [19] | [B1] | 69 | [S3] | 1 | [A1] | 20 | [C1] | 10 |
| [20] | [20] | [20] | [B1] | 69 | [S4] | 1 | [A1] | 20 | [C1] | 10 |
| [21] | [21] | [21] | [B7] | 69 | [S1] | 1 | [A1] | 20 | [C1] | 10 |
| [22] | [22] | [22] | [B8] | 70 | — | 0 | [A1] | 20 | [C1] | 10 |
| [23] | [23] | [23] | [B9] | 70 | — | 0 | [A1] | 20 | [C1] | 10 |
| [24] | [24] | [24] | [B10] | 69 | [S1] | 1 | [A1] | 20 | [C1] | 10 |
| [25] | [25] | [25] | [B10] | 69 | [S1] | 1 | [A5] | 20 | [C1] | 10 |

### [Evaluation]

### <Blocking Resistance>

As the image forming apparats, a color copier bizhnb PRESS C71cf (manufactured by Konica Minolta, Inc.) was prepared that was modified such that the fixing temperature, the toner adhesion amount, and the system speed can be freely set.

An unfixed image of a solid patch having a toner adhesion amount of 10 g/m² and a size of 100 mm square was formed on the resin recording medium using the image forming apparatus and the developers prepared as described above. The image was formed in an environment of a normal temperature and normal humidity (temperature: 20° C., humidity: 50% RH) at a fixing temperature of 150° C. and a system speed of 270 mm/sec. In this image forming apparatus, the resin recording medium in a rolled state is spread and conveyed in the image forming apparatus, and after a toner image is formed thereon, the resin recording medium is again wound in a rolled state. Thus, an image was formed on the resin recording medium that was set in a rolled state and that was again wound in a rolled state and stored after printing.

In Examples 1 to 20 and 22 to 24, a corona-treated polyethylene terephthalate film having a thickness shown in the following table was used as the resin recording medium. In Example 21, a corona-untreated polyethylene terephthalate film having a thickness of 50 μm was used as the resin recording medium.

After printing, the recording medium was left for 24 hours in a rolled state, and the recording medium was slowly spread with a constant force 2N. At the time of spreading, the transfer rate of the image to the recording medium was visually ranked. Ranks A to C were regarded as acceptable.

### (Criteria)

Rank A: Image transfer was not observed (0%).
Rank B: The image transfer rate was greater than 0% and less than 20%.
Rank C: The image transfer rate was 20% or greater and less than 40%.
Rank D: The image transfer rate was 40% or greater.

### <Varnish Coatability>

### (Image Formation)

As the image forming apparatus, a color copier bizhub PRESS C71cf (manufactured by Konica Minolta, Inc.) was prepared that was modified such that the fixing temperature, the toner adhesion amount, and the system speed can be freely set.

The image forming apparatus and each of the developers prepared above were used to form an unfixed image of a solid patch having a toner adhesion amount of 8 g/m² and a size of 30 mm×90 mm on an evaluation paper.

The image was formed in an environment of a normal temperature and normal humidity (temperature: 20° C., humidity: 50% RH) at a fixing temperature of 150° C. and a system speed of 270 mm/sec.

As the evaluation paper, POD-157 gloss coated paper (manufactured by Oji Paper Co., Ltd.) was used.

### (Application of Varnish)

To the formed image, varnish (UV VECTA coat varnish PC-3KW2 manufactured by T&K Co., Ltd) was applied by a bar coater such that the varnish was 5 μm thick. Thereafter, the varnish was irradiated with ultraviolet rays from a high-pressure mercury lamp such that the integrated light amount on the image surface was 120 to 130 mJ/cm². Thus, the varnish was cured, and a varnish layer was formed. The used varnish contained a polymerizable monomer for varnish having a polymerizable functional group including an ethylenic double bond and a photopolymerization initiator (radical polymerization initiator).

### (Evaluation of Coatability)

The surface of the varnish layer of the obtained image was visually examined whether the varnish was clearly repelled or not. When the varnish was not repelled, the number of pinholes in an 10 cm×10 cm area was counted. Based on these results, the varnish coatability was evaluated according to the following evaluation criteria. Ranks A to C were regarded as acceptable.

### (Criteria)

Rank A: No pinholes were found in an 10 cm×10 cm area.
Rank B: One or two pinholes were found in an 10 cm×10 cm area.
Rank C: Three to ten pinholes were found in an 10 cm×10 cm area.
Rank D: 11 or more pinholes were found in an 10 cm×10 cm area, or the varnish was repelled.

### <Heat-Resistant Storage Property>

The toner of 2 g was placed in a 10-ml glass bottle having an inner diameter of 21 mm, the bottle was capped, and the bottle was shaken 600 times at room temperature using a Tap Denser KYT-2000 (manufactured by Seishin Enterprise Co., Ltd.). Thereafter, the bottle was left uncapped at 55° C. and 35% RH for 2 hours. The sample was then taken out, and the mass of the aggregated toner was measured to evaluate the heat-resistant storage stability. The sample taken out from the container was transferred to a 42-mesh sieve so as not to destroy the structure as much as possible, and the sample was vibrated for 30 seconds by a powder measuring machine (REOSTAT, manufactured by Hosokawa Micron Corporation) with the vibration intensity of 4.5. Thereafter, the mass of the toner remaining on the sieve was measured and determined as the mass of the aggregated toner. The aggregation rate (% by mass) of the toner was calculated from the mass of the aggregated toner and the mass of the sample. The storage stability of the toner was evaluated by the following four grades.

### (Criteria)

A: Toner aggregation rate is less than 15% by mass (toner has an excellent storage stability and causes no problem in image formation).
B: Toner aggregation rate is 15 to 45% by mass (toner has a good storage stability and causes no problem in image formation).
C: Toner aggregation rate is 46 to 60% by mass (although toner has a slightly poor storage stability and causes some problems in image formation, it is usable within an acceptable range).
D: Toner aggregation rate exceeds 60% by mass (toner has a poor storage stability and causes problems in image formation, therefore the toner is not usable).

### <Peak Density Spd of Protrusions>

The peak density Spd of protrusions on the surface of the image formed for evaluating the blocking resistance was measured as follows.

The resin recording medium having the image formed thereon was placed on a stage of a laser microscope (VKX-250 manufactured by Keyence Corporation) such that the toner layer side faced upward. The surface of the toner layer was focused with a 10× lens, and surface filter processing was performed on the original front surface to obtain the primary surface and the measurement surface. An evaluation region (entire region: 1425 μm×1425 μm) was defined on the measurement surface, and the reference surface corresponding to the measurement surface was obtained to measure the peak density Spd. The peak density Spd was measured 10 times while the observation place was randomly changed, and the average value thereof was calculated.

TABLE VI

| | | EXAMPLE | EXAMPLE | EXAMPLE | EXAMPLE | EXAMPLE |
|---|---|---|---|---|---|---|
| | | 1 | 2 | 3 | 4 | 5 |
| Toner No. | | [1] | [2] | [3] | [4] | [5] |
| Spd [mm⁻²] | | 29000 | 6500 | 50679 | 5000 | 36000 |
| Content of | | 515 | 515 | 515 | 515 | 1.03 |
| saturated | | | | | | |
| hydrocarbon | | | | | | |
| compound to | | | | | | |
| total mass of | | | | | | |
| toner | | | | | | |
| [mass ppm] | | | | | | |
| Amorphous vinyl | | [S1] | [S1] | [S1] | [S1] | [S1] |
| resin particle | | | | | | |
| dispersion (high | | | | | | |
| molecular body) | | | | | | |
| No. | | | | | | |
| Amorphous vinyl | | [B1] | [B2] | [B1] | [B1] | [B3] |
| resin particle | | | | | | |
| dispersion | | | | | | |
| No. | | | | | | |
| Amorphous | No. | [A1] | [A2] | [A3] | [A4] | [A1] |
| polyester | *1 | 20 | 20 | 20 | 20 | 20 |
| resin | | | | | | |
| particle | | | | | | |
| dispersion | | | | | | |
| Crystalline | | [C1] | [C1] | [C1] | [C1] | [C1] |
| polyester resin | | | | | | |
| particle | | | | | | |
| dispersion | | | | | | |
| No. | | | | | | |
| Thickness of | | 50 | 50 | 50 | 50 | 50 |
| resin recording | | | | | | |
| medium | | | | | | |
| [μm] | | | | | | |
| Corona treatment | | YES | YES | YES | YES | YES |
| on recording | | | | | | |
| medium | | | | | | |
| Blocking | | A | C | A | C | A |
| resistance | | | | | | |
| (Rank) | | | | | | |
| Varnish | | A | A | C | A | B |
| coatability | | | | | | |
| (Rank) | | | | | | |
| Heat-resistant | | A | A | A | A | B |
| preservability | | | | | | |
| | | EXAMPLE | EXAMPLE | EXAMPLE | EXAMPLE | EXAMPLE |
| | | 6 | 7 | 8 | 9 | 10 |
| Toner No. | | [6] | [7] | [8] | [9] | [10] |
| Spd [mm⁻²] | | 22010 | 35500 | 23700 | 92561 | 75030 |
| Content of | | 1000 | 5.17 | 854 | 515 | 515 |
| saturated | | | | | | |
| hydrocarbon | | | | | | |
| compound to | | | | | | |
| total mass of | | | | | | |
| toner | | | | | | |
| [mass ppm] | | | | | | |
| Amorphous vinyl | | [S1] | [S1] | [S1] | [S1] | [S1] |
| resin particle | | | | | | |
| dispersion (high | | | | | | |
| molecular body) | | | | | | |
| No. | | | | | | |
| Amorphous vinyl | | [B4] | [B5] | [B6] | [B1] | [B1] |
| resin particle | | | | | | |
| dispersion | | | | | | |
| No. | | | | | | |
| Amorphous | No. | [A1] | [A1] | [A1] | [A1] | [A1] |
| polyester | *1 | 20 | 20 | 20 | 3 | 5 |
| resin | | | | | | |
| particle | | | | | | |
| dispersion | | | | | | |

| | | | | | |
|---|---|---|---|---|---|
| Crystalline | [C1] | [C1] | [C1] | [C1] | [C1] |
| polyester resin | | | | | |
| particle | | | | | |
| dispersion | | | | | |
| No. | | | | | |
| Thickness of | 50 | 50 | 50 | 50 | 75 |
| resin recording | | | | | |
| medium | | | | | |
| [μm] | | | | | |
| Corona treatment | YES | YES | YES | YES | YES |
| on recording | | | | | |
| medium | | | | | |
| Blocking | B | A | B | A | A |
| resistance | | | | | |
| (Rank) | | | | | |
| Varnish | A | B | A | C | C |
| coatability | | | | | |
| (Rank) | | | | | |
| Heat-resistant | A | B | A | A | A |
| preservability | | | | | |

*1: Content to total binder resin [% by mass]

TABLE VII

| | | EXAMPLE | EXAMPLE | EXAMPLE | EXAMPLE | EXAMPLE |
|---|---|---|---|---|---|---|
| | | 11 | 12 | 13 | 14 | 15 |
| Toner No. | | [11] | [12] | [13] | [14] | [15] |
| Spd [mm⁻²] | | 75000 | 15000 | 38000 | 53400 | 66050 |
| Content of | | 515 | 515 | 515 | 515 | 515 |
| saturated | | | | | | |
| hydrocarbon | | | | | | |
| compound to total | | | | | | |
| mass of toner | | | | | | |
| [mass ppm] | | | | | | |
| Amorphous vinyl | | [S1] | [S1] | [S1] | [S1] | — |
| resin particle | | | | | | |
| dispersion (high | | | | | | |
| molecular body) | | | | | | |
| No. | | | | | | |
| Amorphous vinyl | | [B1] | [B1] | [B1] | [B1] | [B1] |
| resin Particle | | | | | | |
| dispersion | | | | | | |
| No. | | | | | | |
| Amorphous | No. | [A1] | [A1] | [A1] | [A5] | [A6] |
| polyester resin | *1 | 80 | 50 | 85 | 20 | 20 |
| particle | | | | | | |
| dispersion | | | | | | |
| Crystalline | | [C1] | [C1] | [C1] | [C1] | [C1] |
| polyester resin | | | | | | |
| particle dispersion | | | | | | |
| No. | | | | | | |
| Thickness of resin | | 100 | 50 | 50 | 50 | 50 |
| recording medium | | | | | | |
| [μm] | | | | | | |
| Corona treatment on | | YES | YES | YES | YES | YES |
| recording medium | | | | | | |
| Blocking resistance | | A | B | A | A | A |
| (Rank) | | | | | | |
| Varnish coatability | | C | A | B | C | C |
| (Rank) | | | | | | |
| Heat-resistant | | A | A | A | A | A |
| preservability | | | | | | |
| | | EXAMPLE | EXAMPLE | EXAMPLE | EXAMPLE | EXAMPLE |
| | | 16 | 17 | 18 | 19 | 20 |
| Toner No. | | [16] | [17] | [18] | [19] | [20] |
| Spd [mm⁻²] | | 25000 | 36000 | 110000 | 5500 | 150000 |
| Content of | | 515 | 515 | 515 | 515 | 515 |
| saturated | | | | | | |
| hydrocarbon | | | | | | |
| compound to total | | | | | | |
| mass of toner | | | | | | |
| [mass ppm] | | | | | | |
| Amorphous vinyl | | [S1] | [S1] | [S2] | [S3] | [S4] |
| resin particle | | | | | | |
| dispersion (high | | | | | | |
| molecular body) | | | | | | |
| No. | | | | | | |
| Amorphous vinyl | | [B1] | [B1] | [B1] | [B1] | [B1] |
| resin Particle | | | | | | |
| dispersion | | | | | | |
| No. | | | | | | |
| Amorphous | No. | [A1] | [A7] | [A1] | [A1] | [A1] |
| polyester resin | *1 | 20 | 20 | 20 | 20 | 20 |
| particle | | | | | | |
| dispersion | | | | | | |

| | | | | | |
|---|---|---|---|---|---|
| Crystalline | [C2] | [C2] | [C1] | [C1] | [C1] |
| polyester resin | | | | | |
| particle dispersion | | | | | |
| No. | | | | | |
| Thickness of resin | 50 | 50 | 50 | 50 | 50 |
| recording medium | | | | | |
| [μm] | | | | | |
| Corona treatment on | YES | YES | YES | YES | YES |
| recording medium | | | | | |
| Blocking resistance | B | A | A | C | A |
| (Rank) | | | | | |
| Varnish coatability | A | B | C | C | C |
| (Rank) | | | | | |
| Heat-resistant | A | A | A | A | A |
| preservability | | | | | |

*1: Content to total binder resin [% by mass]

TABLE VIII

| | | EXAMPLE | EXAMPLE | EXAMPLE | EXAMPLE | COMPARATIVE | COMPARATIVE |
|---|---|---|---|---|---|---|---|
| | | 21 | 22 | 23 | 24 | EXAMPLE 1 | EXAMPLE 2 |
| Toner No. | | Toner 1 | Toner 21 | Toner 22 | Toner 23 | Toner 24 | Toner 25 |
| Spd [mm⁻²] | | 30000 | 6200 | 6000 | 5800 | 53000 | 3200 |
| Content of saturated | | 515 | 0.52 | 0 | 0 | 1694 | 1694 |
| hydrocarbon compound to total | | | | | | | |
| mass of toner | | | | | | | |
| [mass ppm] | | | | | | | |
| Amorphous vinyl resin particle | | [S1] | [S1] | — | — | [S1] | [S1] |
| dispersion (high molecular | | | | | | | |
| body) | | | | | | | |
| No. | | | | | | | |
| Amorphous vinyl resin particle | | [B1] | [B7] | [B8] | [B9] | [B10] | [B10] |
| dispersion | | | | | | | |
| No. | | | | | | | |
| Amorphous | No. | [A1] | [A1] | [A1] | [A1] | [A1] | [A5] |
| polyester | Content to total | 20 | 20 | 20 | 20 | 20 | 20 |
| resin | binder resin | | | | | | |
| particle | [% by mass] | | | | | | |
| dispersion | | | | | | | |

| | | | | | | |
|---|---|---|---|---|---|---|
| Crystalline polyester resin | [C1] | [C1] | [C1] | [C1] | [C1] | [C1] |
| particle dispersion | | | | | | |
| No. | | | | | | |
| Thickness of resin recording | 50 | 50 | 50 | 50 | 50 | 50 |
| medium | | | | | | |
| [μm] | | | | | | |
| Corona treatment on recording | NO | YES | YES | YES | YES | YES |
| medium | | | | | | |
| Blocking resistance | A | C | C | C | A | D |
| (Rank) | | | | | | |
| Varnish coatability | C | A | A | A | D | B |
| (Rank) | | | | | | |
| Heat-resistant preservability | A | C | C | C | A | A |

As the above result shows, according to the image forming method of the present invention, in which the content of the C16-35 saturated compound is a specific amount or less and an image is formed such that the peak density Spd of protrusions is 5000 mm⁻² or greater, blocking resistance and varnish coatability are improved compared to the comparative examples. It is also apparent that a small content of the C16-35 saturated compounds improves heat-resistant storage stability.

Although embodiments of the present invention have been described and illustrated in detail, the disclosed embodiments are made for purposes of illustration and example only and not limitation. The scope of the present invention should be interpreted by terms of the appended claims.

1. An electrophotographic image forming method comprising fixing an electrostatic charge image developing toner onto a resin recording medium to form an image, wherein:
a content of a saturated hydrocarbon compound having 16 to 35 carbon atoms is 1,000 ppm by mass or less with respect to a total mass of the electrostatic charge image developing toner, and
when an image having an adhesion amount of 4 g/m² or greater is formed on the resin recording medium, a peak density Spd of protrusions on a surface of the image is 5,000 mm⁻² or greater.

2. The image forming method according to claim 1, wherein the content of the saturated hydrocarbon compound is 1 ppm by mass or greater with respect to the total mass of the electrostatic charge image developing toner.

3. The image forming method according to claim 1, wherein the resin recording medium is a continuous-form medium.

4. The image forming method according to claim 1, wherein a thickness of the resin recording medium is 75 μm or less.

5. The image forming method according to claim 1, wherein the resin recording medium is a polyethylene terephthalate film having a thickness of 50 μm.

6. The image forming method according to claim 1, wherein:
the electrostatic charge image developing toner contains a binding resin, and
the binding resin contains at least an amorphous polyester and a crystalline polyester.

7. The image forming method according to claim 6, wherein a percentage of a content of the amorphous polyester in the binding resin is in a range of 5 to 80% by mass.

8. The image forming method according to claim 6, wherein a polyhydric alcohol of the amorphous polyester is an aliphatic polyhydric alcohol or an alicyclic polyhydric alcohol.

9. The image forming method according to claim 8, wherein the polyhydric alcohol is an acyclic aliphatic polyhydric alcohol having 5 or more carbon atoms.

10. The image forming method according to claim 6, wherein the binding resin contains an amorphous resin having a weight-average molecular weight in a range of 50,000 to 500,000.

11. The image forming method according to claim 1, further comprising applying varnish.

12. An electrophotographic image forming system that includes an electrostatic charge image developing toner and forms an image by fixing the electrostatic charge image developing toner, wherein:
a content of a saturated hydrocarbon compound having 16 to 35 carbon atoms is 1,000 ppm by mass or less with respect to a total mass of the electrostatic charge image developing toner, and
when an image having an adhesion amount of 4 g/m² or greater is formed on a resin recording medium, a peak density Spd of protrusions on a surface of the image is 5,000 mnr² or greater.
